(19) United States
(12) Patent Application Publication
(10) Pub. No.: US 2026/0252167 A1
(43) Pub. Date: Aug. 27, 2026

(54) SYSTEM

(71) Applicant: SoftBank Group Corp., Tokyo (JP)

(72) Inventor: Momoko INOKUMA, Tokyo (JP)

(73) Assignee: SoftBank Group Corp., Tokyo (JP)

(21) Appl. No.: 19/534,803

(22) Filed: Feb. 10, 2026

(30) Foreign Application Priority Data
Feb. 21, 2025 (JP) 2025-026990

(51) Int. Cl. G06F 3/01

(52) U.S. Cl. CPC G06F 3/011; G06F 2203/011

(57) ABSTRACT

The system according to the embodiment comprises a collection unit, an analysis unit, an evaluation unit, and a provision unit. The collection unit collects data. The analysis unit analyzes the data collected by the collection unit and filters important information. The evaluation unit provides evaluation support based on the information filtered by the analysis unit. The provision unit provides the information obtained by the evaluation unit to a user in real time.

### CROSS-REFERENCE TO RELATED APPLICATION

The present application claims priority to and incorporates by reference the entire contents of Japanese Patent Application No. 2025-026990 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there is room for improvement because big data collected has not been sufficiently analyzed in real time, and important information has not been adequately filtered and provided.

### SUMMARY OF THE INVENTION

The system according to the embodiment comprises a collection unit, an analysis unit, an evaluation unit, and a provision unit. The collection unit collects data. The analysis unit analyzes the data collected by the collection unit and filters important information. The evaluation unit provides evaluation support based on the information filtered by the analysis unit. The provision unit provides the information obtained by the evaluation unit to a user in real time.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

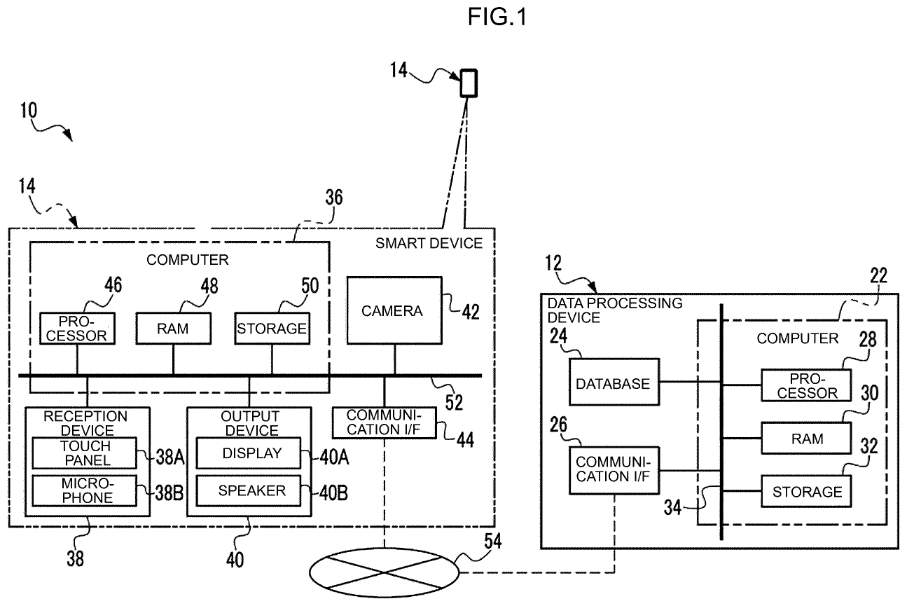

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

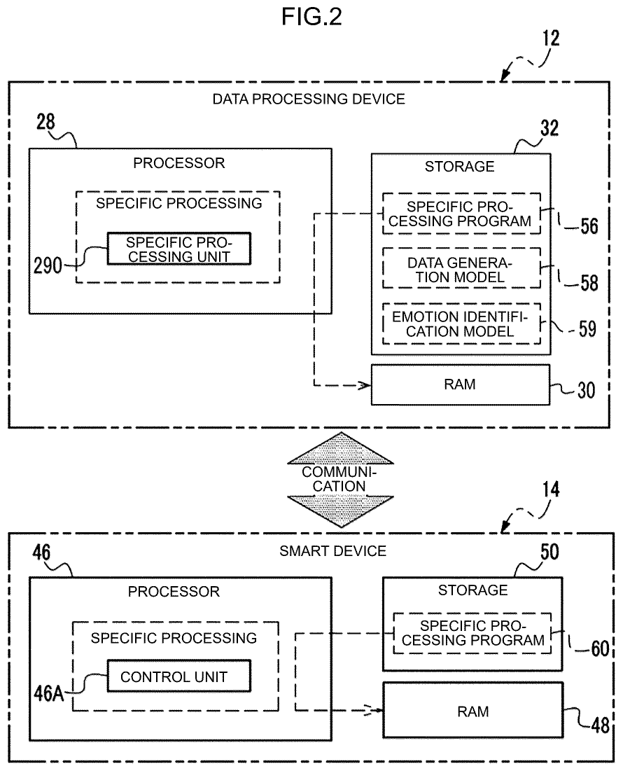

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The information provision system according to the embodiment of the present invention is a system that analyzes data collected as big data via IoT devices in real time and simultaneously performs information filtering and evaluation support. By combining this information provision system with generative AI, it becomes possible to easily obtain accurate and safe information in real time. This system is in demand among people who require time to understand their surroundings, such as hearing-impaired individuals who cannot comprehend train or facility broadcasts. For example, the information provision system collects various data inside trains and facilities using IoT devices (temperature sensors, humidity sensors, voice sensors, surveillance cameras, etc.). These data are transmitted to the cloud in real time. Next, generative AI analyzes these data on the cloud. Based on the collected data, the generative AI filters important information and provides evaluation support. For example, it converts broadcast content inside a train into text and displays it to hearing-impaired individuals. It also analyzes emergency broadcasts within a facility and presents appropriate evacuation routes. Furthermore, based on the analysis results, the generative AI provides information to users in real time. For example, it sends notifications to smartphones or tablets so that users can immediately obtain necessary information. As a result, hearing-impaired individuals and people who require time to understand their surroundings can easily obtain accurate and safe information in real time. Specifically, this information provision system uploads diverse data collected from IoT devices (e.g., one-dimensional time-series temperature data from temperature sensors, one-dimensional time-series humidity data from humidity sensors, 16 kHz sampled voice waveform data from voice sensors, sequences of 1920×1080 pixel image frames from surveillance cameras, etc.) to a cloud database in real time via edge devices or gateways. The system performs preprocessing (e.g., noise removal, normalization, feature extraction, voice segment detection, image resizing, etc.) on these data before inputting them into the generative AI module. As generative AI, for example, a Transformer-based large language model (LLM) or a multimodal generative AI that integrally handles images, voice, and text (e.g., a combination of Vision Transformer and voice recognition model) can be used. Examples of AI inputs include: (1) 10 seconds of voice waveform data obtained from a voice sensor (16,000 samples×10 seconds=160,000 points in a one-dimensional array); (2) consecutive image frames from a surveillance camera (10 frames, each frame 1920×1080 pixels); (3) one-minute time-series data from temperature and humidity sensors (each 60-point numerical vector), and so on. For voice data, the AI applies voice recognition algorithms (e.g., RNN or Transformer-based voice recognition models using CTC loss) to convert broadcast content into text. For image data, object detection and anomaly detection algorithms (e.g., YOLO or ResNet-based CNN) are applied to extract congestion status and hazardous areas. For text data, natural language processing algorithms (e.g., BERT or LLM) are used to extract important keywords and perform semantic analysis. AI outputs include: (1) text conversion results of broadcast content (e.g., strings such as “The next station is Shinjuku”); (2) classification labels for emergency broadcast content (e.g., “fire alarm,” “earthquake alert,” etc.); (3) recommended evacuation paths (e.g., coordinate sequences on facility maps); (4) information reliability scores (real values from 0.0 to 1.0), and so on. These outputs are used in subsequent evaluation units for threshold judgment (e.g., only notifications with reliability above 0.8), branching processing according to user attributes (e.g., text notifications for hearing-impaired users, voice notifications for visually impaired users), and so forth. Conventional human information transmission has faced difficulties in real-time response, integration of diverse data, and simultaneous analysis of multiple modalities, but this system achieves significant improvements in information accuracy, immediacy, and safety by enabling AI-based automatic feature extraction, integration, and judgment in high-dimensional data spaces. Application fields include real-time information support in various IoT environments such as public transportation, commercial facilities, hospitals, airports, and factories. Furthermore, for AI model training, past broadcast data, emergency behavior history, user feedback data, etc. are used, and weight optimization is performed based on loss functions (e.g., cross-entropy, MSE), enabling continuous accuracy improvement and enhanced environmental adaptability. Thus, the present invention fundamentally improves the processing efficiency, accuracy, and reliability of computer technology itself, rather than merely automating human tasks.

The information provision system according to the embodiment comprises a collection unit, an analysis unit, an evaluation unit, and a provision unit. The collection unit collects data. The data may include, for example, sensor data, text data, voice data, and the like, but is not limited to such examples. The collection unit collects data using, for example, a temperature sensor, a humidity sensor, a voice sensor, and a surveillance camera. The temperature sensor may be of various types with different measurement ranges and accuracies, selected according to specific environments. Similarly, the humidity sensor may be of various types with different measurement ranges and accuracies, selected according to the environment. The voice sensor may be of various types with different sensitivities and frequency ranges, used to detect specific voices. The surveillance camera may be of various types with different resolutions and viewing angles, used to monitor specific areas. The analysis unit uses generative AI to analyze the data collected by the collection unit and filter important information. Important information is filtered, for example, based on threshold settings or specific keywords. Generative AI, such as a text generative AI (e.g., LLM), analyzes the collected data and extracts important information. Additionally, generative AI may use multimodal generative AI to integrally analyze multiple data modalities. The evaluation unit provides evaluation support based on the information filtered by the analysis unit. Evaluation support is performed, for example, based on evaluation algorithms or evaluation items. The evaluation unit uses AI to evaluate the filtered information and provide useful information to the user. The provision unit provides the information obtained by the evaluation unit to the user in real time. The provision unit sends notifications to a smartphone or tablet so that the user can immediately obtain necessary information. Notifications may be provided in formats such as push notifications or email notifications. Thus, the information provision system according to the embodiment can efficiently perform data collection, analysis, evaluation, and provision. Specifically, this information provision system uploads diverse data obtained from IoT devices such as temperature sensors, humidity sensors, voice sensors, and surveillance cameras (e.g., one-dimensional time-series temperature data, one-dimensional time-series humidity data, 16 kHz sampled voice waveform data, sequences of 1920×1080 pixel image frames, etc.) to a cloud database in real time via edge devices or gateways. The system performs preprocessing (e.g., noise removal, normalization, feature extraction, voice segment detection, image resizing, etc.) on these data before inputting them into the generative AI module of the analysis unit. As generative AI, a Transformer-based large language model or a multimodal generative AI that integrally handles images, voice, and text (e.g., a combination of Vision Transformer and voice recognition model) can be used. Examples of AI inputs include: voice waveform data obtained from a voice sensor for 10 seconds (16,000 samples×10 seconds=160,000 points in a one-dimensional array); consecutive image frames from a surveillance camera (10 frames, each frame 1920×1080 pixels); one-minute time-series data from temperature and humidity sensors (each 60-point numerical vector), and so on. The analysis unit applies voice recognition algorithms (e.g., RNN or Transformer-based voice recognition models using CTC loss) to voice data to convert broadcast content into text. For image data, object detection and anomaly detection algorithms (e.g., YOLO or ResNet-based CNN) are applied to extract congestion status and hazardous areas. For text data, natural language processing algorithms (e.g., BERT or LLM) are used to extract important keywords and perform semantic analysis. AI outputs include: text conversion results of broadcast content (e.g., strings such as “The next station is Shinjuku”); classification labels for emergency broadcast content (e.g., “fire alarm,” “earthquake alert,” etc.); recommended evacuation paths (e.g., coordinate sequences on facility maps); information reliability scores (real values from 0.0 to 1.0), and so on. These outputs are used in the evaluation unit for threshold judgment (e.g., only notifications with reliability above 0.8), branching processing according to user attributes (e.g., text notifications for hearing-impaired users, voice notifications for visually impaired users), and so forth. The evaluation unit determines whether the AI output is useful information for the user based on reliability and content classification, and optimizes the evaluation algorithm as needed by referring to past evaluation history and user attribute information. The provision unit notifies the user terminal of useful information from the evaluation unit in real time, and optimizes the notification format (push notification, email notification, voice notification, etc.) according to the terminal type, battery level, and user's current situation. Thus, this system achieves real-time response, integration of diverse data, and simultaneous analysis of multiple modalities, which were difficult with conventional human operations, and demonstrates significant technical effects in improving the accuracy, immediacy, and safety of information. Application fields include real-time information support in various IoT environments such as public transportation, commercial facilities, hospitals, airports, and factories. Furthermore, for AI model training, past broadcast data, emergency behavior history, user feedback data, etc. are used, and weight optimization is performed based on loss functions (e.g., cross-entropy, MSE), enabling continuous accuracy improvement and enhanced environmental adaptability. Thus, the present invention fundamentally improves the processing efficiency, accuracy, and reliability of computer technology itself, rather than merely automating human tasks.

The collection unit can collect data using a temperature sensor, a humidity sensor, a voice sensor, and a surveillance camera. The temperature sensor may be of various types with different measurement ranges and accuracies, selected according to specific environments. Similarly, the humidity sensor may be of various types with different measurement ranges and accuracies, selected according to the environment. The voice sensor may be of various types with different sensitivities and frequency ranges, used to detect specific voices. The surveillance camera may be of various types with different resolutions and viewing angles, used to monitor specific areas. By using various sensors, detailed data can be collected. Some or all of the above-described processing in the collection unit may be performed using AI, or may be performed without using AI. For example, the collection unit may input data obtained from temperature sensors, humidity sensors, voice sensors, and surveillance cameras into generative AI and have the generative AI perform data analysis. Specifically, the collection unit obtains diverse data in real time, such as one-dimensional time-series temperature data from a temperature sensor (e.g., 60 samples per minute, each sample being a Celsius temperature value), one-dimensional time-series humidity data from a humidity sensor (e.g., 60 samples per minute, each sample being a relative humidity percentage), 16 kHz sampled voice waveform data from a voice sensor (e.g., 160,000 points in a one-dimensional array for 10 seconds), and sequences of 1920×1080 pixel image frames from a surveillance camera (e.g., 10 frames per second). Before uploading these data to a cloud database via edge devices or gateways, the collection unit can perform preprocessing such as noise removal (e.g., moving average filter or band-pass filter), normalization (e.g., Z-score normalization), feature extraction (e.g., voice segment detection, image resizing or histogram equalization), and so on. Furthermore, the collection unit can automatically perform data quality judgment and anomaly detection (e.g., sudden changes in temperature sensor values or abnormal noise detection in voice sensors) using AI modules (e.g., Transformer-based large language models or multimodal generative AI). Examples of AI inputs include: (1) one-minute time-series data from a temperature sensor (60-point numerical vector); (2) 10 seconds of voice waveform data from a voice sensor (160,000 points in a one-dimensional array); (3) consecutive image frames from a surveillance camera (10 frames, each frame 1920×1080 pixels), and so on. The AI outputs for these input data include: (a) anomaly detection scores (real values from 0.0 to 1.0); (b) data quality labels (e.g., “normal,” “abnormal,” “reacquisition required”); (c) feature vectors (e.g., MFCC features for voice, embedding vectors for images), and so on. These outputs are used in subsequent analysis units or evaluation units for data adoption judgment, reacquisition instructions, data integration processing, and so forth. Conventional human data collection has faced difficulties in real-time response, integration of various sensors, and automation of anomaly detection, but the collection unit demonstrates significant technical effects in improving the accuracy, immediacy, and reliability of data collection by enabling AI-based automatic feature extraction, quality judgment, and anomaly detection in high-dimensional data spaces. Application fields include high-precision data collection in various IoT environments such as smart buildings, equipment monitoring in factories, patient monitoring in medical settings, and safety monitoring in public transportation. Furthermore, for AI model training, past sensor data, anomaly occurrence history, feedback data from field operators, etc. are used, and weight optimization is performed based on loss functions (e.g., cross-entropy, MSE), enabling continuous accuracy improvement and enhanced environmental adaptability. Thus, the present invention fundamentally improves the data collection efficiency, accuracy, and reliability of computer technology itself, rather than merely automating human tasks.

The analysis unit can convert broadcast content inside a train into text based on the collected data. Broadcast content inside a train may include, for example, announcement content and broadcast language, but is not limited to such examples. The analysis unit uses generative AI to convert broadcast content inside a train into text based on the collected data. For example, generative AI receives voice data as input and converts it into text using voice recognition technology. Generative AI can extract important information from the voice data and display it as text. By converting broadcast content inside a train into text, information can be provided to hearing-impaired individuals. Some or all of the above-described processing in the analysis unit may be performed using AI, or may be performed without using AI. For example, the analysis unit may obtain broadcast content inside a train as voice data, input it into generative AI, and have the generative AI perform conversion from voice data to text data. Specifically, the analysis unit receives 16 kHz sampled voice waveform data obtained from a voice sensor (e.g., 160,000 points in a one-dimensional array for 10 seconds) as input. The analysis unit first performs preprocessing such as noise removal (e.g., spectral subtraction), voice segment detection (e.g., energy threshold method), and normalization (e.g., amplitude normalization). Then, a voice recognition AI module (e.g., Transformer-based voice recognition model using CTC loss or RNN-based voice recognition model) extracts phoneme sequences or word sequences from the voice waveform and finally converts them into text. Examples of AI inputs include: (1) Japanese announcement voice waveform data (e.g., “ [symbol] ”), (2) English announcement voice waveform data (e.g., “The next station is Shinjuku”), and so on. The AI outputs for these inputs include: (a) text conversion results (e.g., strings such as “ [symbol] [symbol] ”), (b) language identification labels (e.g., “Japanese,” “English”), (c) reliability scores (real values from 0.0 to 1.0), and so on. These outputs are used in subsequent evaluation units for threshold judgment (e.g., only notifications with reliability above 0.8), branching processing according to user attributes (e.g., text notifications for hearing-impaired users, voice notifications for visually impaired users), and so forth. Conventional human voice recognition has faced difficulties in real-time response, multilingual support, and high-precision recognition in noisy environments, but the analysis unit demonstrates significant technical effects in improving the accuracy, immediacy, and multilingual support of text conversion of broadcast content by enabling AI-based automatic feature extraction, voice recognition, and language identification in high-dimensional voice data spaces. Application fields include support for in-vehicle broadcasts in public transportation, support for facility broadcasts in airports and commercial facilities, and support for voice information transmission in medical settings. Furthermore, for AI model training, past broadcast voice data, multilingual voice corpora, user feedback data, etc. are used, and weight optimization is performed based on loss functions (e.g., cross-entropy, CTC loss), enabling continuous accuracy improvement and enhanced environmental adaptability. Thus, the present invention fundamentally improves the voice recognition efficiency, accuracy, and reliability of computer technology itself, rather than merely automating human tasks.

The analysis unit can analyze emergency broadcasts within a facility based on the collected data and present appropriate evacuation routes. Emergency broadcasts may include, for example, fire alarms and evacuation instructions, but are not limited to such examples. The analysis unit uses generative AI to analyze emergency broadcasts within a facility based on the collected data and present appropriate evacuation routes. For example, generative AI receives voice data as input and analyzes the content of emergency broadcasts using voice recognition technology. Based on the content of the emergency broadcast, generative AI calculates the optimal evacuation route and presents it to the user. By analyzing emergency broadcasts and presenting appropriate evacuation routes, safe evacuation is supported. Some or all of the above-described processing in the analysis unit may be performed using AI, or may be performed without using AI. For example, the analysis unit may obtain emergency broadcasts within a facility as voice data, input them into generative AI, and have the generative AI present evacuation routes based on the voice data. Specifically, the analysis unit receives 16 kHz sampled emergency broadcast voice waveform data obtained from a voice sensor (e.g., 160,000 points in a one-dimensional array for 10 seconds) as input. The analysis unit first performs preprocessing such as noise removal (e.g., spectral subtraction), voice segment detection, and normalization. Then, a voice recognition AI module (e.g., Transformer-based voice recognition model using CTC loss) converts the voice waveform into text for emergency broadcast content. The AI applies natural language processing AI (e.g., BERT or large language models) to the text to classify the type of emergency broadcast (e.g., “fire alarm,” “earthquake alert,” “evacuation instruction”). Furthermore, the AI integrates facility map data (e.g., graph data with node-edge structure) and current congestion status data (e.g., congestion heat maps extracted from surveillance camera images) to calculate the optimal evacuation route. Examples of AI inputs include: (1) emergency broadcast voice waveform data, (2) facility map data (node coordinates and connection information), (3) congestion heat maps (images or numerical matrices), and so on. The AI outputs for these inputs include: (a) text conversion results of emergency broadcast content, (b) classification labels for emergency broadcasts, (c) recommended evacuation paths (e.g., coordinate sequences on facility maps), (d) safety scores for each route (real values from 0.0 to 1.0), and so on. These outputs are used in subsequent provision units for notifications to user terminals, map display, voice guidance generation, and so forth. Conventional human analysis of emergency broadcasts and presentation of evacuation routes has faced difficulties in real-time response, integration of multiple information sources, and automation of optimal route calculation, but the analysis unit demonstrates significant technical effects in improving the accuracy, immediacy, and safety of evacuation support by enabling AI-based automatic feature extraction, broadcast content analysis, and route optimization in high-dimensional data spaces. Application fields include emergency evacuation support in large buildings such as commercial facilities, airports, hospitals, and factories. Furthermore, for AI model training, past emergency broadcast voice data, evacuation behavior history, user feedback data, etc. are used, and weight optimization is performed based on loss functions (e.g., cross-entropy, route cost minimization), enabling continuous accuracy improvement and enhanced environmental adaptability. Thus, the present invention fundamentally improves the efficiency, accuracy, and reliability of emergency broadcast analysis and evacuation route presentation in computer technology itself, rather than merely automating human tasks.

The provision unit can send notifications to a smartphone or tablet so that the user can immediately obtain necessary information. Notifications may include, for example, push notifications or email notifications, but are not limited to such examples. The provision unit uses AI to notify a smartphone or tablet of information obtained by the evaluation unit. For example, the provision unit receives information from the evaluation unit and sends it to the user as a push notification. The provision unit can also send information as an email notification. By sending notifications to a smartphone or tablet, the user can immediately obtain necessary information. Some or all of the above-described processing in the provision unit may be performed using AI, or may be performed without using AI. For example, the provision unit may input information from the evaluation unit into generative AI and have the generative AI generate notifications. Specifically, the provision unit receives information from the evaluation unit (e.g., text conversion results of broadcast content, classification labels for emergency broadcasts, recommended evacuation paths, information reliability scores, etc.) as input. The provision unit obtains terminal information such as user terminal type (e.g., smartphone, tablet, smartwatch, etc.), screen size, battery level, and user attributes (e.g., hearing-impaired, visually impaired, etc.), and determines the optimal notification format. Examples of AI inputs include: (1) information package from the evaluation unit (structured data in JSON format), (2) user terminal information (screen size, OS type, battery level, etc.), (3) user attribute information (type of disability, language settings, etc.), and so on. The AI outputs for these inputs include: (a) selection results for notification format (e.g., “push notification,” “email notification,” “voice notification”), (b) automatic generation of notification content (e.g., “The next station is Shinjuku,” “Fire alarm: Here is the evacuation route,” etc.), (c) notification priority labels (e.g., “high,” “medium,” “low”), (d) notification transmission timing (e.g., immediate, delayed, linked to user schedule), and so on. These outputs are used in subsequent notification transmission modules for actual notification delivery to terminals, user interface display, input to speech synthesis engines, and so forth. Conventional human information notification has faced difficulties in real-time response, terminal optimization, and automation linked to user attributes, but the provision unit demonstrates significant technical effects in improving the immediacy, individual optimization, and user satisfaction of information provision by enabling AI-based automatic selection of notification format, content generation, and priority judgment. Application fields include passenger guidance in public transportation, emergency information notification in commercial facilities, patient support in medical settings, and safety notifications for workers in factories. Furthermore, for AI model training, past notification history, user feedback, terminal usage data, etc. are used, and weight optimization is performed based on loss functions (e.g., cross-entropy, maximization of user satisfaction), enabling continuous accuracy improvement and enhanced environmental adaptability. Thus, the present invention fundamentally improves the efficiency, accuracy, and user adaptability of information notification in computer technology itself, rather than merely automating human tasks.

The collection unit can estimate a user's emotion and adjust the timing of data collection based on the estimated emotion of the user. For example, if the user is feeling stressed, the collection unit reduces the frequency of data collection to alleviate the user's burden. If the user is relaxed, the collection unit increases the frequency of data collection to collect more detailed information. Furthermore, if the user is in an emergency situation, the collection unit maximizes the frequency of data collection to enable rapid response. By adjusting the timing of data collection according to the user's emotion, the user's burden can be reduced. Emotion estimation is realized using, for example, an emotion engine or generative AI with emotion estimation functions. Generative AI may be a text generative AI (e.g., LLM) or a multimodal generative AI, but is not limited to such examples. Some or all of the above-described processing in the collection unit may be performed using AI, or may be performed without using AI. For example, the collection unit may input the user's emotion data into generative AI and have the generative AI perform emotion estimation. Specifically, the collection unit obtains the user's biometric sensor data (e.g., one-dimensional time-series heart rate data, one-dimensional array of skin conductance response, sequences of face image frames, voice waveform data, text chat history, etc.) in real time and inputs them into an AI module on an edge device or in the cloud. The collection unit performs preprocessing such as noise removal (e.g., band-pass filter), normalization (e.g., Z-score normalization), and feature extraction (e.g., extraction of facial expression feature vectors from face images, extraction of MFCC features from voice, extraction of emotion words from text). Examples of AI inputs include: (1) one-minute time-series heart rate data (60-point numerical vector), (2) 10 seconds of voice waveform data (16,000 samples×10 seconds=160,000 points in a one-dimensional array), (3) face image frames (10 frames, each frame 128×128 pixels), (4) text chat history (e.g., strings such as “I'm tired today”), and so on. The collection unit inputs these data into a multimodal generative AI (e.g., Transformer-based multimodal emotion estimation model), and the AI outputs: (a) emotion labels (e.g., “stress,” “relaxed,” “emergency,” etc.), (b) emotion intensity scores (real values from 0.0 to 1.0), (c) confidence scores for emotion estimation (real values from 0.0 to 1.0), and so on. For example, if the heart rate is high and the face image shows a furrowed brow, a “stress” label and a high intensity score are output. If anger features are extracted from the voice waveform, an “emergency” label is output. These AI outputs are used in subsequent data collection control modules for threshold judgment (e.g., halve collection frequency if stress intensity is above 0.7), branching processing (e.g., collect data every second in emergencies), and so forth. The technical effect of the present invention is that AI automatically estimates the user's emotional state in high-dimensional data space and dynamically optimizes data collection timing based on the estimation results, thereby achieving both reduced user burden and immediate acquisition of necessary information. Real-time emotion-adaptive data collection, which was difficult with conventional human operations or simple rule-based control, is realized by AI-based multimodal integration, automatic feature extraction, and threshold judgment, greatly improving the efficiency, accuracy, and user experience of the entire system. Application fields include wearable health management, stress monitoring, emergency notification systems, smart home environment control, and passenger support in public transportation. Furthermore, for AI model training, past biometric sensor data with emotion labels, user feedback, abnormal behavior history, etc. are used, and weight optimization is performed based on loss functions (e.g., cross-entropy, MSE), enabling continuous accuracy improvement and enhanced environmental adaptability. Thus, the present invention fundamentally improves the data collection efficiency, accuracy, and user adaptability of computer technology itself, rather than merely automating human tasks.

The collection unit can analyze past data collection history and select an appropriate collection method. For example, the collection unit determines the most efficient sensor arrangement based on past data collection history. The collection unit can also select the optimal data collection time period based on past data collection history. Furthermore, the collection unit can analyze past data collection history to eliminate unnecessary data collection. By analyzing past data collection history, the optimal collection method can be selected. Some or all of the above-described processing in the collection unit may be performed using AI, or may be performed without using AI. For example, the collection unit may input past data collection history into generative AI and have the generative AI select the optimal collection method. Specifically, the collection unit maintains a structured database of past data collection history, including collection times for each sensor, collection locations, amount of collected data, collection success rates, environmental parameters at the time of collection (e.g., temperature, humidity, noise level, etc.), and quality evaluation scores for collected data (e.g., anomaly rate, missing rate, reliability score, etc.). The collection unit inputs these history data as time-series vectors (e.g., daily transitions of collection success rates), categorical data (e.g., sensor type, installation location), and numerical matrices (e.g., collection efficiency matrix for each sensor and each time period) into the AI module. Examples of AI inputs include: (1) time-series data of temperature sensor collection success rates for the past 30 days (30-point real value vector), (2) cross-table of collected data amount and quality scores for each sensor type, (3) collection efficiency heat map for each time period (24 hours×7 days numerical matrix), and so on. The collection unit inputs these data into a Transformer-based time-series analysis model or multimodal generative AI, and the AI outputs: (a) optimal sensor arrangement patterns (e.g., coordinate lists or arrangement maps), (b) recommended collection time periods (e.g., time labels such as 6:00-8:00 AM, 5:00-7:00 PM), (c) list of unnecessary collection points (e.g., sensor ID list with collection efficiency below threshold), (d) suggestions for improving collection methods (e.g., optimization of sampling intervals, proposals for switching sensor types), and so on. For example, the AI generates specific suggestions such as “Recommend rearrangement for sensors with collection success rate below 80% in the past 30 days” or “Halve collection frequency during nighttime due to high noise.” These AI outputs are automatically reflected in sensor arrangement plans and collection schedules in subsequent collection control modules, enabling elimination of unnecessary data collection and efficient resource allocation. Conventional human history analysis has faced difficulties in deriving optimal solutions from vast amounts of data, but the collection unit demonstrates significant technical effects in improving the efficiency, accuracy, and resource optimization of data collection by enabling AI-based automatic pattern extraction, optimization, and suggestion generation in high-dimensional history data spaces. Application fields include sensor network optimization in smart buildings, equipment monitoring planning in factories, patient monitoring scheduling in medical settings, and environmental data collection optimization in public transportation. Furthermore, for AI model training, past collection history data, optimization results, feedback from field operators, abnormal response history, etc. are used, and weight optimization is performed based on loss functions (e.g., maximization of collection efficiency, minimization of unnecessary collection), enabling continuous accuracy improvement and enhanced environmental adaptability. Thus, the present invention fundamentally improves the efficiency, accuracy, and reliability of data collection planning in computer technology itself, rather than merely automating human tasks.

The collection unit can perform filtering during data collection based on the user's current situation or field of interest. For example, if the user is inside a train, the collection unit preferentially collects data related to broadcast content inside the train. If the user is within a facility, the collection unit preferentially collects data related to emergency broadcasts within the facility. Furthermore, the collection unit can also preferentially collect data related to the user's field of interest. By filtering data based on the user's current situation or field of interest, necessary information can be preferentially collected. Some or all of the above-described processing in the collection unit may be performed using AI, or may be performed without using AI. For example, the collection unit may input the user's current situation or field of interest into generative AI and have the generative AI perform data filtering. Specifically, the collection unit obtains the user's current location information (e.g., GPS coordinates, Wi-Fi beacon ID), movement history, device usage status (e.g., app launch history, screen operation logs), and user profile (e.g., field of interest tags, past information browsing history) in real time and inputs them as structured data (e.g., attribute vectors in JSON format) into the AI module. Examples of AI inputs include: (1) location information vector when the current location is determined to be “inside a train,” (2) user profile with field of interest set to “disaster prevention” or “traffic information,” (3) device usage status flag such as “voice guidance app is running,” and so on. The collection unit inputs these data into a multimodal generative AI (e.g., Transformer-based situation recognition model), and the AI outputs: (a) data categories to be preferentially collected (e.g., “train broadcast,” “facility emergency broadcast,” “traffic delay information,” etc.), (b) selection results for target sensors to be collected (e.g., voice sensor priority, surveillance camera priority, etc.), (c) optimization parameters for collection frequency (e.g., every 1 minute, every 5 minutes, etc.), (d) filtering rules (e.g., data not matching the field of interest are excluded from collection), and so on. For example, the AI automatically generates specific collection policies such as “If the user is inside a train and interested in disaster prevention, prioritize collection of emergency broadcasts and congestion status data,” or “When staying within a facility, focus on collecting evacuation route information.” These AI outputs are reflected in real time in subsequent collection control modules, enabling data collection optimized for the user's situation and field of interest. Conventional human situation judgment and field of interest filtering have faced difficulties in real-time response and integration of diverse data, but the collection unit demonstrates significant technical effects in improving the efficiency, accuracy, and user adaptability of information collection by enabling AI-based automatic situation recognition, filtering, and collection optimization in high-dimensional attribute spaces. Application fields include passenger support in public transportation, personalized information provision in commercial facilities, patient situation-adaptive monitoring in medical settings, and environment control in smart homes. Furthermore, for AI model training, past situation data and collection results, user feedback, information acquisition history by field of interest, etc. are used, and weight optimization is performed based on loss functions (e.g., maximization of necessary information acquisition rate, minimization of unnecessary information collection), enabling continuous accuracy improvement and enhanced environmental adaptability. Thus, the present invention fundamentally improves the efficiency, accuracy, and user adaptability of information collection in computer technology itself, rather than merely automating human tasks.

The collection unit can estimate a user's emotion and determine the priority of data to be collected based on the estimated emotion of the user. For example, if the user is feeling stressed, the collection unit preferentially collects only important data. If the user is relaxed, the collection unit preferentially collects detailed data. Furthermore, if the user is in an emergency situation, the collection unit can also preferentially collect highly urgent data. By determining the priority of data to be collected according to the user's emotion, important data can be preferentially collected. Emotion estimation is realized using, for example, an emotion engine or generative AI with emotion estimation functions. Generative AI may be a text generative AI (e.g., LLM) or a multimodal generative AI, but is not limited to such examples. Some or all of the above-described processing in the collection unit may be performed using AI, or may be performed without using AI. For example, the collection unit may input the user's emotion data into generative AI and have the generative AI determine the priority of data. Specifically, the collection unit obtains the user's biometric sensor data (e.g., time-series heart rate vector, one-dimensional array of skin conductance response), sequences of face image frames, voice waveform data, text chat history, etc. in real time, performs preprocessing (e.g., noise removal, normalization, feature extraction), and inputs them into the AI module. Examples of AI inputs include: (1) one-minute time-series heart rate data (60-point numerical vector), (2) 10 seconds of voice waveform data (160,000 points in a one-dimensional array), (3) face image frames (10 frames, each frame 128×128 pixels), (4) text chat history (e.g., strings such as “I'm tired today”), and so on. The collection unit inputs these data into a Transformer-based multimodal emotion estimation model, and the AI outputs: (a) emotion labels (e.g., “stress,” “relaxed,” “emergency,” etc.), (b) emotion intensity scores (real values from 0.0 to 1.0), (c) confidence scores for emotion estimation (real values from 0.0 to 1.0). For example, if the heart rate is high and the face image shows a furrowed brow, a “stress” label and a high intensity score are output. If anger features are extracted from the voice waveform, an “emergency” label is output. Based on these AI outputs, the data collection priority determination module automatically determines: (a) data categories to be collected (e.g., in emergencies, “safety information,” “evacuation routes,” etc. are prioritized); (b) collection frequency (e.g., every 1 minute during stress, every 10 seconds during relaxation); (c) collection granularity (e.g., only summary data during stress, detailed data during relaxation). Thus, the system can preferentially collect important data according to the user's emotional state, achieving both reduced user burden and immediate acquisition of necessary information. Real-time emotion-adaptive data collection, which was difficult with conventional human operations or simple rule-based control, is realized by AI-based multimodal integration, automatic feature extraction, and threshold judgment, greatly improving the efficiency, accuracy, and user experience of the entire system. Application fields include wearable health management, stress monitoring, emergency notification systems, smart home environment control, and passenger support in public transportation. Furthermore, for AI model training, past biometric sensor data with emotion labels, user feedback, abnormal behavior history, etc. are used, and weight optimization is performed based on loss functions (e.g., cross-entropy, MSE), enabling continuous accuracy improvement and enhanced environmental adaptability. Thus, the present invention fundamentally improves the data collection efficiency, accuracy, and user adaptability of computer technology itself, rather than merely automating human tasks.

The collection unit can preferentially collect highly relevant data during data collection based on the user's geographic location information. For example, if the user is in a specific region, the collection unit preferentially collects data related to that region. If the user is moving, the collection unit preferentially collects data related to the destination region. Furthermore, if the user is in a specific facility, the collection unit can also preferentially collect data related to that facility. By preferentially collecting highly relevant data based on the user's geographic location information, necessary information can be efficiently collected. Some or all of the above-described processing in the collection unit may be performed using AI, or may be performed without using AI. For example, the collection unit may input the user's geographic location information into generative AI and have the generative AI collect highly relevant data. Specifically, the collection unit obtains geographic location information such as GPS coordinates, Wi-Fi beacon ID, base station information, and facility location tags (e.g., QR codes, BLE beacons) from the user terminal in real time and inputs them as structured data (e.g., latitude/longitude vectors, facility ID, floor number, etc.) into the AI module. Examples of AI inputs include: (1) current GPS coordinates (e.g., 35.6895, 139.6917), (2) time-series coordinate sequence of movement route (e.g., 10-minute movement history), (3) facility location tag information (e.g., area B on the 3rd floor of commercial facility A), and so on. The collection unit inputs these data into a geospatial recognition AI (e.g., Transformer-based location information processing model or graph neural network), and the AI outputs: (a) data categories related to the current location or destination (e.g., “regional weather information,” “traffic conditions,” “facility event information,” etc.), (b) sensor types to be preferentially collected (e.g., voice sensors in stations, surveillance cameras in commercial facilities, etc.), (c) range of target areas for collection (e.g., within a 100 m radius, entire facility, etc.), (d) optimization parameters for collection frequency (e.g., every 1 minute while moving, every 5 minutes while staying), and so on. For example, the AI automatically generates specific collection policies such as “If the user is in an airport, prioritize collection of flight information and congestion status,” or “While moving, focus on collecting weather and traffic information around the destination.” These AI outputs are reflected in real time in subsequent collection control modules, enabling information collection optimized for the user's geographic location. Conventional human location-linked collection has faced difficulties in real-time response and simultaneous handling of multiple locations, but the collection unit demonstrates significant technical effects in improving the efficiency, accuracy, and user adaptability of information collection by enabling AI-based automatic relevance judgment and collection optimization in high-dimensional geospatial data. Application fields include regional information provision in smart cities, passenger guidance in public transportation, personalized information distribution in commercial facilities, and evacuation support during disasters. Furthermore, for AI model training, past location information and collection results, user feedback, information acquisition history by region, etc. are used, and weight optimization is performed based on loss functions (e.g., maximization of relevant information acquisition rate, minimization of unnecessary information collection), enabling continuous accuracy improvement and enhanced environmental adaptability. Thus, the present invention fundamentally improves the efficiency, accuracy, and user adaptability of location-linked data collection in computer technology itself, rather than merely automating human tasks.

The collection unit can analyze the user's social media activity during data collection and collect relevant data. For example, if the user mentions a specific topic on social media, the collection unit collects data related to that topic. If the user participates in a specific event on social media, the collection unit collects data related to that event. Furthermore, the collection unit can also analyze the user's social media activity and preferentially collect data of high interest. By analyzing the user's social media activity, data of high interest can be preferentially collected. Some or all of the above-described processing in the collection unit may be performed using AI, or may be performed without using AI. For example, the collection unit may input the user's social media activity data into generative AI and have the generative AI collect relevant data. Specifically, the collection unit obtains the user's social media posting history (e.g., text posts, image posts, video posts), posting times, posting location information, event participation information (e.g., event name, venue, participation date and time), and tags or hashtags attached to posts in real time and inputs them as structured data (e.g., post content vectors, tag lists, event IDs, etc.) into the AI module. Examples of AI inputs include: (1) text posting history for the past week (e.g., string list such as “Went to a new cafe,” “Participated in a disaster prevention event”), (2) hashtag list attached to posts (e.g., “#traffic information,” “#event name”), (3) metadata of participated events (e.g., event name, venue, date and time), and so on. The collection unit inputs these data into a natural language processing AI (e.g., BERT or large language model) or multimodal generative AI, and the AI outputs: (a) extraction results of user interest topics (e.g., category labels such as “cafe,” “disaster prevention,” “traffic”), (b) data categories to be preferentially collected (e.g., sensor data or event information related to interest topics), (c) list of target events to be collected (e.g., event IDs scheduled for participation this week), (d) optimization parameters for collection frequency and granularity (e.g., collect detailed data at high frequency for topics of high interest), and so on. For example, the AI automatically generates specific collection policies such as “If the user frequently uses the #disaster prevention tag, prioritize collection of disaster prevention-related information,” or “Focus on collecting information about upcoming events based on event participation history.” These AI outputs are reflected in real time in subsequent collection control modules, enabling information collection optimized for the user's social media activity. Conventional human post analysis and interest estimation have faced difficulties in real-time response and integration of diverse data, but the collection unit demonstrates significant technical effects in improving the efficiency, accuracy, and user adaptability of information collection by enabling AI-based automatic interest extraction and collection optimization in high-dimensional posting data spaces. Application fields include personalized information provision, event guidance, disaster information distribution, and promotion optimization in commercial facilities. Furthermore, for AI model training, past posting data and collection results, user feedback, event participation history, etc. are used, and weight optimization is performed based on loss functions (e.g., maximization of interest information acquisition rate, minimization of unnecessary information collection), enabling continuous accuracy improvement and enhanced environmental adaptability. Thus, the present invention fundamentally improves the efficiency, accuracy, and user adaptability of social media-linked data collection in computer technology itself, rather than merely automating human tasks.

The analysis unit can estimate a user's emotion and adjust the expression method of analysis based on the estimated emotion of the user. For example, if the user is nervous, the analysis unit provides simple and highly visible analysis results. If the user is relaxed, the analysis unit provides detailed analysis results. Furthermore, if the user is in a hurry, the analysis unit can also provide concise analysis results that focus on key points. By adjusting the expression method of analysis according to the user's emotion, analysis results that are easy for the user to understand can be provided. Emotion estimation is realized using, for example, an emotion engine or generative AI with emotion estimation functions. Generative AI may be a text generative AI (e.g., LLM) or a multimodal generative AI, but is not limited to such examples. Some or all of the above-described processing in the analysis unit may be performed using AI, or may be performed without using AI. For example, the analysis unit may input the user's emotion data into generative AI and have the generative AI adjust the expression method of analysis. Specifically, the analysis unit obtains the user's biometric sensor data (e.g., one-minute time-series heart rate vector, one-dimensional array of skin conductance response), sequences of face image frames (e.g., 10 frames, each frame 128×128 pixels), voice waveform data (e.g., 160,000 points in a one-dimensional array for 10 seconds), text chat history (e.g., strings such as “I'm nervous today”), and so on in real time, performs preprocessing (e.g., noise removal, normalization, feature extraction), and inputs them into a multimodal emotion estimation AI (e.g., Transformer-based multimodal model). The analysis unit obtains from the AI: (a) emotion labels (e.g., “nervous,” “relaxed,” “in a hurry,” etc.), (b) emotion intensity scores (real values from 0.0 to 1.0), (c) confidence scores for emotion estimation (real values from 0.0 to 1.0). For example, if the heart rate is high and the face image shows a furrowed brow, a “nervous” label and a high intensity score are output. If features of fast speech or high pitch are extracted from the voice waveform, an “in a hurry” label is output. Based on these AI outputs, the analysis unit automatically determines the expression method of analysis results. For example, if the “nervous” label and intensity score are above 0.7, the analysis result is displayed concisely in bullet points and limited to calm colors. If the “relaxed” label is present, the analysis result is generated with detailed graphs and supplementary explanations. If the “in a hurry” label is present, a short summary emphasizing key points is generated. Examples of AI inputs include: (1) one-minute time-series heart rate data (60-point numerical vector), (2) face image frames (10 frames), (3) voice waveform data (160,000 points in a one-dimensional array), (4) text chat history (e.g., “I'm nervous today”). Examples of AI outputs include: (1) emotion label “nervous,” intensity 0.8, confidence 0.9; (2) emotion label “relaxed,” intensity 0.3, confidence 0.95; (3) emotion label “in a hurry,” intensity 0.7, confidence 0.85. These outputs are used in subsequent analysis result generation modules for branching of expression methods (e.g., detailed display/simple display/key point display) and UI layout optimization (e.g., font size, color scheme, presence of graphs). Conventional human presentation of analysis results has faced difficulties in dynamic optimization of expression according to the user's emotional state, but the analysis unit demonstrates significant technical effects in improving the understanding, satisfaction, and user experience of analysis results by enabling AI-based automatic emotion estimation and expression optimization in high-dimensional emotion data spaces. Application fields include presentation of analysis results to patients in medical settings, learner-adaptive feedback in education, passenger guidance in public transportation, and stress monitoring systems. Furthermore, for AI model training, past emotion data and analysis result presentation history, user feedback, abnormal behavior history, etc. are used, and weight optimization is performed based on loss functions (e.g., maximization of user understanding, minimization of misunderstanding rate), enabling continuous accuracy improvement and enhanced environmental adaptability. Thus, the present invention fundamentally improves the efficiency, accuracy, and user adaptability of analysis result presentation in computer technology itself, rather than merely automating human tasks.

The analysis unit can adjust the level of detail of analysis during analysis based on the importance of the data. For example, the analysis unit performs detailed analysis for highly important data. For less important data, the analysis unit can perform simplified analysis. Furthermore, the analysis unit can also determine the priority of analysis according to the importance of the data. By adjusting the level of detail of analysis based on the importance of the data, efficient analysis becomes possible. Some or all of the above-described processing in the analysis unit may be performed using AI, or may be performed without using AI. For example, the analysis unit may input the importance of the data into generative AI and have the generative AI adjust the level of detail of analysis. Specifically, the analysis unit assigns importance scores to various data received from the collection unit (e.g., time-series data from temperature sensors, voice waveform data, image frames, text data, etc.). Importance scores are calculated based on AI-based automatic judgment (e.g., anomaly detection score, user interest score, urgency score) or past usage history, user attributes, and system settings. Examples of AI inputs include: (1) time-series data from temperature sensors with anomaly detection scores (e.g., score 0.9), (2) emergency broadcast voice data with urgency score (e.g., score 0.95), (3) text data with user interest score (e.g., score 0.7), and so on. The analysis unit inputs these data into a Transformer-based importance judgment model or multimodal generative AI, and the AI outputs: (a) analysis detail level labels (e.g., “detailed,” “standard,” “simple”), (b) analysis priority (e.g., integer values from 1 to 5), (c) selection results for data to be analyzed (e.g., only data with importance above 0.8 are analyzed in detail). For example, the AI automatically generates specific analysis policies such as “Perform detailed analysis for voice data with urgency score 0.95” or “Perform simplified analysis for data with interest score below 0.5.” These AI outputs are used in subsequent analysis execution modules for algorithm branching according to detail level (e.g., multi-stage feature extraction, anomaly detection, cause analysis for detailed analysis; summary generation only for simplified analysis) and resource allocation optimization (e.g., allocation of GPU computing resources). Conventional human judgment of importance and adjustment of analysis detail level has faced difficulties in real-time optimization for vast amounts of data, but the analysis unit demonstrates significant technical effects in improving the efficiency, accuracy, and resource optimization of analysis by enabling AI-based automatic optimization of detail level and priority determination in high-dimensional importance data spaces. Application fields include equipment anomaly monitoring in factories, urgency judgment in medical settings, operation information analysis in public transportation, and environmental monitoring in smart buildings. Furthermore, for AI model training, past importance judgment history and analysis results, user feedback, abnormal response history, etc. are used, and weight optimization is performed based on loss functions (e.g., maximization of analysis efficiency, minimization of misjudgment), enabling continuous accuracy improvement and enhanced environmental adaptability. Thus, the present invention fundamentally improves the efficiency, accuracy, and resource optimization of analysis in computer technology itself, rather than merely automating human tasks.

The analysis unit can apply different analysis algorithms during analysis according to the category of the data. For example, the analysis unit applies voice recognition algorithms to voice data. The analysis unit can also apply image recognition algorithms to image data. Furthermore, the analysis unit can also apply natural language processing algorithms to text data. By applying different analysis algorithms according to the category of the data, the accuracy of analysis is improved. Some or all of the above-described processing in the analysis unit may be performed using AI, or may be performed without using AI. For example, the analysis unit may input the category of the data into generative AI and have the generative AI select the analysis algorithm to be applied. Specifically, the analysis unit inputs various data received from the collection unit (e.g., voice waveform data, image frames, text data, time-series sensor data, etc.) into a data category classification AI (e.g., Transformer-based multimodal classification model), and the AI outputs: (a) data category labels (e.g., “voice,” “image,” “text,” “time-series,” etc.), (b) recommended analysis algorithms (e.g., “CTC voice recognition,” “YOLO object detection,” “BERT natural language processing,” “LSTM time-series analysis,” etc.). Examples of AI inputs include: (1) 16 kHz sampled voice waveform data (160,000 points in a one-dimensional array), (2) 1920×1080 pixel image frames, (3) text data (e.g., “The next station is Shinjuku”), (4) one-minute time-series data from temperature sensors (60-point numerical vector), and so on. Examples of AI outputs include: (1) category “voice,” recommended algorithm “CTC voice recognition”; (2) category “image,” recommended algorithm “YOLO object detection”; (3) category “text,” recommended algorithm “BERT natural language processing.” Based on the AI output, the analysis unit automatically selects and applies the optimal analysis algorithm for each data category. For example, Transformer-based voice recognition models for voice data, CNN-based object detection models for image data, large language models for text data, and LSTM or Transformer-based time-series analysis models for time-series data. These analysis results are used in subsequent evaluation units and provision units for information integration and notification generation. Conventional human judgment of data category and selection of algorithms has faced difficulties in real-time response and integration of diverse data, but the analysis unit demonstrates significant technical effects in improving the accuracy, efficiency, and scalability of analysis by enabling AI-based automatic category classification and algorithm optimization in high-dimensional data spaces. Application fields include integrated analysis of various sensors in smart buildings, multimodal diagnostic support in medical settings, information analysis in public transportation, and equipment monitoring in factories. Furthermore, for AI model training, past data category judgment history and analysis results, user feedback, abnormal response history, etc. are used, and weight optimization is performed based on loss functions (e.g., maximization of category judgment accuracy, minimization of misclassification), enabling continuous accuracy improvement and enhanced environmental adaptability. Thus, the present invention fundamentally improves the accuracy, efficiency, and scalability of analysis in computer technology itself, rather than merely automating human tasks.

The analysis unit can adjust the length of analysis during analysis based on the estimated emotion of the user. For example, if the user is in a hurry, the analysis unit provides a short and concise analysis result. If the user is relaxed, the analysis unit provides a detailed analysis result. Furthermore, if the user is excited, the analysis unit can also provide a visually stimulating analysis result. By adjusting the length of analysis according to the user's emotion, the optimal analysis result can be provided to the user. Emotion estimation is realized using, for example, an emotion engine or generative AI with emotion estimation functions. Generative AI may be a text generative AI (e.g., LLM) or a multimodal generative AI, but is not limited to such examples. Some or all of the above-described processing in the analysis unit may be performed using AI, or may be performed without using AI. For example, the analysis unit may input the user's emotion data into generative AI and have the generative AI adjust the length of analysis. Specifically, the analysis unit obtains the user's biometric sensor data (e.g., one-minute time-series heart rate vector, one-dimensional array of skin conductance response), sequences of face image frames (e.g., 10 frames, each frame 128×128 pixels), voice waveform data (e.g., 160,000 points in a one-dimensional array for 10 seconds), text chat history (e.g., strings such as “I'm in a hurry today”), and so on in real time, performs preprocessing (e.g., noise removal, normalization, feature extraction), and inputs them into a multimodal emotion estimation AI (e.g., Transformer-based multimodal model). The analysis unit obtains from the AI: (a) emotion labels (e.g., “in a hurry,” “relaxed,” “excited,” etc.), (b) emotion intensity scores (real values from 0.0 to 1.0), (c) confidence scores for emotion estimation (real values from 0.0 to 1.0). For example, if the heart rate is high and features of fast speech are extracted from the voice waveform, an “in a hurry” label and a high intensity score are output. If the face image shows a smile and wide-open eyes, an “excited” label is output. Based on these AI outputs, the analysis unit automatically determines the length and expression format of analysis results. For example, if the “in a hurry” label and intensity score are above 0.7, the analysis result is displayed as a summary within three lines, omitting graphs and detailed explanations. If the “relaxed” label is present, the analysis result is generated with detailed graphs and supplementary explanations. If the “excited” label is present, the analysis result is generated with visually stimulating elements such as colors and animations. Examples of AI inputs include: (1) one-minute time-series heart rate data (60-point numerical vector), (2) face image frames (10 frames), (3) voice waveform data (160,000 points in a one-dimensional array), (4) text chat history (e.g., “I'm in a hurry today”). Examples of AI outputs include: (1) emotion label “in a hurry,” intensity 0.8, confidence 0.9; (2) emotion label “relaxed,” intensity 0.3, confidence 0.95; (3) emotion label “excited,” intensity 0.7, confidence 0.85. These outputs are used in subsequent analysis result generation modules for branching of length and expression format (e.g., summary display/detailed display/visual emphasis display) and UI layout optimization (e.g., font size, color scheme, presence of animation). Conventional human presentation of analysis results has faced difficulties in dynamic optimization of length according to the user's emotional state, but the analysis unit demonstrates significant technical effects in improving the understanding, satisfaction, and user experience of analysis results by enabling AI-based automatic emotion estimation and length optimization in high-dimensional emotion data spaces. Application fields include presentation of analysis results to patients in medical settings, learner-adaptive feedback in education, passenger guidance in public transportation, and stress monitoring systems. Furthermore, for AI model training, past emotion data and analysis result presentation history, user feedback, abnormal behavior history, etc. are used, and weight optimization is performed based on loss functions (e.g., maximization of user understanding, minimization of misunderstanding rate), enabling continuous accuracy improvement and enhanced environmental adaptability. Thus, the present invention fundamentally improves the efficiency, accuracy, and user adaptability of analysis result presentation in computer technology itself, rather than merely automating human tasks.

The analysis unit can determine the priority of analysis during analysis based on the timing of data collection. For example, the analysis unit preferentially analyzes the latest data. The analysis unit can also analyze the latest data while referring to past data. Furthermore, the analysis unit can also determine the order of analysis according to the timing of data collection. By determining the priority of analysis based on the timing of data collection, the latest information can be preferentially analyzed. Some or all of the above-described processing in the analysis unit may be performed using AI, or may be performed without using AI. For example, the analysis unit may input the timing of data collection into generative AI and have the generative AI determine the priority of analysis. Specifically, the analysis unit assigns collection times or timestamps to various data received from the collection unit (e.g., time-series data from temperature sensors, voice waveform data, image frames, text data, etc.) and inputs them as time-series vectors or structured data into the AI module. Examples of AI inputs include: (1) temperature sensor data for the past 24 hours (each data with timestamp), (2) latest emergency broadcast voice data (with collection time), (3) image frame sequences for one week (each frame with collection time), and so on. The analysis unit inputs these data into a Transformer-based time-series analysis model or multimodal generative AI, and the AI outputs: (a) analysis priority list (e.g., analyze in order from latest data), (b) reference data set (e.g., past similar case data), (c) optimization parameters for analysis order (e.g., time-series priority considering urgency and importance), and so on. For example, the AI automatically generates specific analysis policies such as “Analyze data collected within the past hour with highest priority” or “Analyze latest data with reference to past abnormal occurrence data.” These AI outputs are used in subsequent analysis execution modules for automatic determination of analysis order and resource allocation optimization (e.g., preferential allocation of GPU computing resources to latest data). Conventional human time-series data analysis and priority determination have faced difficulties in real-time optimization for vast amounts of data, but the analysis unit demonstrates significant technical effects in improving the efficiency, immediacy, and freshness of information in analysis by enabling AI-based automatic priority determination and order optimization in high-dimensional time-series data spaces. Application fields include equipment anomaly monitoring in factories, vital sign analysis in medical settings, operation information analysis in public transportation, and environmental monitoring in smart buildings. Furthermore, for AI model training, past time-series data and analysis results, user feedback, abnormal response history, etc. are used, and weight optimization is performed based on loss functions (e.g., minimization of analysis delay, maximization of information freshness), enabling continuous accuracy improvement and enhanced environmental adaptability. Thus, the present invention fundamentally improves the efficiency, immediacy, and freshness of information in analysis in computer technology itself, rather than merely automating human tasks.

The analysis unit can adjust the order of analysis during analysis based on the relevance of the data. For example, the analysis unit preferentially analyzes highly relevant data. The analysis unit can also postpone analysis of less relevant data. Furthermore, the analysis unit can also adjust the order of analysis according to the relevance of the data. By adjusting the order of analysis based on the relevance of the data, efficient analysis becomes possible. Some or all of the above-described processing in the analysis unit may be performed using AI, or may be performed without using AI. For example, the analysis unit may input the relevance of the data into generative AI and have the generative AI adjust the order of analysis. Specifically, the analysis unit calculates the relevance between various data received from the collection unit (e.g., time-series data from temperature sensors, voice waveform data, image frames, text data, etc.) using AI-based automatic judgment (e.g., correlation coefficient calculation, co-occurrence frequency analysis, user interest matching) or past usage history, user attributes, and system settings. Examples of AI inputs include: (1) time-series data from multiple sensors (e.g., simultaneous variation of temperature and humidity), (2) simultaneous acquisition timestamps of voice data and image data, (3) data sets with user interest scores, and so on. The analysis unit inputs these data into a graph neural network or Transformer-based relevance judgment model, and the AI outputs: (a) data relevance score matrix (real values from 0.0 to 1.0 for each data pair), (b) analysis order list (e.g., analyze in order of highest relevance score), (c) grouping results for data to be analyzed (e.g., simultaneously analyze highly relevant data), and so on. For example, the AI automatically generates specific analysis policies such as “Simultaneously analyze temperature and humidity when their variation is high” or “Perform linked analysis when voice and image are acquired simultaneously.” These AI outputs are used in subsequent analysis execution modules for automatic determination of analysis order, group analysis, and resource allocation optimization (e.g., preferential allocation of GPU computing resources to highly relevant data). Conventional human judgment of data relevance and adjustment of analysis order have faced difficulties in real-time optimization for vast amounts of data, but the analysis unit demonstrates significant technical effects in improving the efficiency, accuracy, and information integration of analysis by enabling AI-based automatic relevance judgment and order optimization in high-dimensional data spaces. Application fields include equipment anomaly monitoring in factories, multi-item vital sign analysis in medical settings, composite information analysis in public transportation, and environmental monitoring in smart buildings. Furthermore, for AI model training, past relevance judgment history and analysis results, user feedback, abnormal response history, etc. are used, and weight optimization is performed based on loss functions (e.g., maximization of analysis efficiency, minimization of misjudgment), enabling continuous accuracy improvement and enhanced environmental adaptability. Thus, the present invention fundamentally improves the efficiency, accuracy, and information integration of analysis in computer technology itself, rather than merely automating human tasks.

The evaluation unit can estimate a user's emotion and adjust the evaluation method based on the estimated emotion of the user. For example, if the user is nervous, the evaluation unit provides a simple and highly visible evaluation method. If the user is relaxed, the evaluation unit provides a detailed evaluation method. Furthermore, if the user is in a hurry, the evaluation unit can also provide a concise evaluation method that focuses on key points. By adjusting the evaluation method according to the user's emotion, evaluation results that are easy for the user to understand can be provided. Emotion estimation is realized using, for example, an emotion engine or generative AI with emotion estimation functions. Generative AI may be a text generative AI (e.g., LLM) or a multimodal generative AI, but is not limited to such examples. Some or all of the above-described processing in the evaluation unit may be performed using AI, or may be performed without using AI. For example, the evaluation unit may input the user's emotion data into generative AI and have the generative AI adjust the evaluation method. Specifically, the evaluation unit obtains the user's biometric sensor data (e.g., one-minute time-series heart rate vector, one-dimensional array of skin conductance response), sequences of face image frames (e.g., 10 frames, each frame 128×128 pixels), voice waveform data (e.g., 160,000 points in a one-dimensional array for 10 seconds), text chat history (e.g., strings such as “I'm nervous today”), and so on in real time, performs preprocessing (e.g., noise removal, normalization, feature extraction), and inputs them into a multimodal emotion estimation AI (e.g., Transformer-based multimodal model). The evaluation unit obtains from the AI: (a) emotion labels (e.g., “nervous,” “relaxed,” “in a hurry,” etc.), (b) emotion intensity scores (real values from 0.0 to 1.0), (c) confidence scores for emotion estimation (real values from 0.0 to 1.0). For example, if the heart rate is high and the face image shows a furrowed brow, a “nervous” label and a high intensity score are output. If features of fast speech or high pitch are extracted from the voice waveform, an “in a hurry” label is output. Based on these AI outputs, the evaluation unit automatically determines the expression format of the evaluation method. For example, if the “nervous” label and intensity score are above 0.7, the evaluation result is displayed concisely in bullet points and limited to calm colors. If the “relaxed” label is present, the evaluation result is generated with detailed graphs and supplementary explanations. If the “in a hurry” label is present, a short summary emphasizing key points is generated. Examples of AI inputs include: (1) one-minute time-series heart rate data (60-point numerical vector), (2) face image frames (10 frames), (3) voice waveform data (160,000 points in a one-dimensional array), (4) text chat history (e.g., “I'm nervous today”). Examples of AI outputs include: (1) emotion label “nervous,” intensity 0.8, confidence 0.9; (2) emotion label “relaxed,” intensity 0.3, confidence 0.95; (3) emotion label “in a hurry,” intensity 0.7, confidence 0.85. These outputs are used in subsequent evaluation result generation modules for branching of expression methods (e.g., detailed display/simple display/key point display) and UI layout optimization (e.g., font size, color scheme, presence of graphs). The evaluation unit demonstrates significant technical effects in improving the understanding, satisfaction, and user experience of evaluation results by enabling AI-based automatic emotion estimation and expression optimization in high-dimensional emotion data spaces, which was difficult with conventional human presentation of evaluation results. Application fields include presentation of evaluation results to patients in medical settings, learner-adaptive feedback in education, passenger guidance in public transportation, and stress monitoring systems. Furthermore, for AI model training, past emotion data and evaluation result presentation history, user feedback, abnormal behavior history, etc. are used, and weight optimization is performed based on loss functions (e.g., maximization of user understanding, minimization of misunderstanding rate), enabling continuous accuracy improvement and enhanced environmental adaptability. Thus, the present invention fundamentally improves the efficiency, accuracy, and user adaptability of evaluation result presentation in computer technology itself, rather than merely automating human tasks.

The evaluation unit can optimize the evaluation algorithm by referring to past evaluation data during evaluation. For example, the evaluation unit optimizes the evaluation algorithm based on past evaluation data. Furthermore, the evaluation unit can refer to past evaluation data to improve the accuracy of evaluation. Additionally, the evaluation unit can analyze past evaluation data to eliminate evaluation bias. Thus, by referring to past evaluation data, the evaluation algorithm can be optimized. Some or all of the above-described processes in the evaluation unit may be performed using AI, or may be performed without using AI. For example, the evaluation unit can input past evaluation data into a generative AI and have the generative AI execute optimization of the evaluation algorithm. Specifically, the evaluation unit maintains structured data as a past evaluation database, including evaluation target data, evaluation time, evaluator ID, evaluation score, evaluation criteria, reliability score of evaluation results, and environmental parameters at the time of evaluation (e.g., user attributes, device type, usage status, etc.). The evaluation unit inputs these historical data into the AI module as time-series vectors (e.g., daily evaluation accuracy trends), categorical data (e.g., evaluator attributes, evaluation criteria), and numerical matrices (e.g., accuracy matrix for each evaluation criterion×each evaluator). Examples of AI inputs include: (1) a time-series vector of evaluation accuracy trends over the past 30 days (30 real values), (2) distribution of evaluation scores by evaluation criterion, and (3) bias indicator matrix by evaluator attribute. The evaluation unit inputs these data into a Transformer-based time-series analysis model or a multimodal generative AI, and the AI outputs (a) optimal evaluation algorithm parameters (e.g., weight coefficients, threshold values), (b) bias correction coefficients (e.g., correction values for each attribute), and (c) proposals for improving evaluation accuracy (e.g., introduction of new features, review of evaluation criteria). For example, the AI generates specific optimization proposals such as “adjust weights if a particular evaluator's bias is high over the past 30 days” or “add new features if the accuracy of evaluation criterion A is declining.” These AI outputs are automatically reflected in subsequent evaluation execution modules, updating algorithm parameters and evaluation criteria, thereby achieving continuous improvement in evaluation accuracy and bias elimination. Conventional human analysis of history and algorithm optimization made it difficult to derive optimal solutions from vast amounts of data, but the evaluation unit achieves significant technical effects by performing automatic pattern extraction, optimization, and bias correction in high-dimensional historical data space using AI, greatly improving evaluation accuracy, efficiency, and reliability. Application fields include optimization of evaluation algorithms for medical diagnosis support, optimization of grading criteria in education, service evaluation for public transportation, and quality control evaluation in factories. Furthermore, for AI model training, past evaluation data, optimization results, user feedback, and response history during anomalies are used, and weight optimization is performed based on loss functions (e.g., maximizing evaluation accuracy, minimizing bias), enabling continuous improvement in accuracy and enhanced environmental adaptability. Thus, the present invention fundamentally improves the efficiency, accuracy, and reliability of evaluation algorithm optimization in computer technology itself, going beyond mere automation of human tasks.

The evaluation unit can perform evaluation by considering attribute information of the data submitter during evaluation. For example, the evaluation unit evaluates by considering the expertise of the data submitter. Furthermore, the evaluation unit can refer to the past evaluation history of the data submitter for evaluation. Additionally, the evaluation unit can eliminate evaluation bias based on the attribute information of the data submitter. Thus, by considering the attribute information of the data submitter, the accuracy of evaluation is improved. Some or all of the above-described processes in the evaluation unit may be performed using AI, or may be performed without using AI. For example, the evaluation unit can input attribute information of the data submitter into a generative AI and have the generative AI execute the evaluation. Specifically, the evaluation unit maintains a structured database of the data submitter's field of expertise, occupation, qualifications, past evaluation history (e.g., adoption rate of submitted data, past evaluation scores), submitter reliability score, and attribute information (e.g., age, affiliated organization, region). The evaluation unit inputs these attribute data into the AI module as categorical vectors (e.g., field of expertise ID, occupation code), numerical vectors (e.g., reliability score, adoption rate), and historical matrices (e.g., submitted data×evaluation score). Examples of AI inputs include: (1) field of expertise ID and past adoption rate of the submitter, (2) reliability score and distribution of past evaluation scores, and (3) bias indicator matrix by submitter attribute. The evaluation unit inputs these data into a Transformer-based attribute evaluation model or multimodal generative AI, and the AI outputs (a) estimated reliability value of submitted data (real value from 0.0 to 1.0), (b) bias correction coefficients (e.g., correction values for each attribute), and (c) proposals for automatic adjustment of evaluation criteria (e.g., weighting of evaluation criteria according to field of expertise). For example, the AI automatically generates specific evaluation policies such as “add reliability if the field of expertise matches” or “apply bias correction if past adoption rate is low.” These AI outputs are used in subsequent evaluation execution modules for weighting evaluation results by reliability score, bias correction, and automatic adjustment of evaluation criteria. Conventional human consideration of attributes and bias elimination made it difficult to reflect vast submitter information in real time, but the evaluation unit achieves significant technical effects by performing automatic reliability estimation, bias correction, and evaluation criteria optimization in high-dimensional attribute data space using AI, greatly improving evaluation accuracy, fairness, and reliability. Application fields include peer review support for academic papers, reliability evaluation of medical diagnostic data, evaluation of information providers for public transportation, and quality control data evaluation in factories. Furthermore, for AI model training, past submitter attribute data, evaluation results, user feedback, and response history during anomalies are used, and weight optimization is performed based on loss functions (e.g., maximizing evaluation accuracy, minimizing bias), enabling continuous improvement in accuracy and enhanced environmental adaptability. Thus, the present invention fundamentally improves the efficiency, accuracy, and fairness of attribute-considering evaluation in computer technology itself, going beyond mere automation of human tasks.

The evaluation unit can estimate a user's emotion and determine the priority of evaluation based on the estimated emotion of the user. For example, if the user is feeling stressed, the evaluation unit prioritizes important evaluations. Furthermore, if the user is relaxed, the evaluation unit can prioritize detailed evaluations. Additionally, if the user is in an emergency situation, the evaluation unit can prioritize evaluations with high urgency. Thus, by determining the priority of evaluation according to the user's emotion, important evaluations can be prioritized. Emotion estimation is realized, for example, by using an emotion engine or generative AI with emotion estimation functionality. Generative AI may include text generation AI (e.g., LLM) or multimodal generative AI, but is not limited to these examples. Some or all of the above-described processes in the evaluation unit may be performed using AI, or may be performed without using AI. For example, the evaluation unit can input the user's emotion data into a generative AI and have the generative AI determine the priority of evaluation. Specifically, the evaluation unit acquires in real time the user's biometric sensor data (e.g., time-series vector of heart rate, one-dimensional array of skin conductance), sequence of facial image frames, voice waveform data, and text chat history, and inputs these, after preprocessing (e.g., noise removal, normalization, feature extraction), into the AI module. Examples of AI inputs include: (1) one-minute time-series data of heart rate (vector of 60 values), (2) ten-second voice waveform data (one-dimensional array of 160,000 values), (3) facial image frames (10 frames, each 128×128 pixels), and (4) text chat history (e.g., strings such as “I'm tired today”). The evaluation unit inputs these data into a Transformer-based multimodal emotion estimation model, and the AI outputs (a) emotion labels (e.g., “stress,” “relaxation,” “emergency,” etc.), (b) emotion intensity scores (real values from 0.0 to 1.0), and (c) confidence scores for emotion estimation (real values from 0.0 to 1.0). For example, if the heart rate is high and the facial image shows a furrowed brow, a “stress” label and high intensity score are output. If features of anger are extracted from the voice waveform, an “emergency” label is output. Based on these AI outputs, the evaluation priority determination module automatically determines (a) a priority list of evaluation target data (e.g., in emergencies, “safety information,” “evacuation routes,” etc. are prioritized), (b) timing of evaluation execution (e.g., during stress, only important data are evaluated immediately; during relaxation, detailed data are also evaluated), and (c) evaluation granularity (e.g., in emergencies, key points are evaluated; during relaxation, detailed evaluation is performed). Thus, the system can prioritize important evaluations according to the user's emotional state, achieving both reduced user burden and immediate acquisition of necessary information. Real-time emotion-adaptive evaluation priority control, which was difficult with conventional human work or simple rule-based control, is realized by AI-based multimodal integration, automatic feature extraction, and threshold judgment, resulting in significant technical effects that greatly improve system efficiency, accuracy, and user experience. Application fields include wearable health management, stress monitoring, emergency notification systems, smart home environment control, and passenger support in public transportation. Furthermore, for AI model training, past biometric sensor data, emotion-labeled training data, user feedback, and behavioral history during anomalies are used, and weight optimization is performed based on loss functions (e.g., cross-entropy, MSE), enabling continuous improvement in accuracy and enhanced environmental adaptability. Thus, the present invention fundamentally improves the efficiency, accuracy, and user adaptability of evaluation in computer technology itself, going beyond mere automation of human tasks.

The evaluation unit can perform evaluation by considering the geographic distribution of data during evaluation. For example, the evaluation unit performs region-specific evaluation based on the geographic distribution of data. Furthermore, the evaluation unit can eliminate evaluation bias based on geographic distribution. Additionally, the evaluation unit can improve evaluation accuracy by considering geographic distribution. Thus, by considering the geographic distribution of data, region-specific evaluation becomes possible. Some or all of the above-described processes in the evaluation unit may be performed using AI, or may be performed without using AI. For example, the evaluation unit can input the geographic distribution of data into a generative AI and have the generative AI execute the evaluation. Specifically, the evaluation unit maintains a structured database of geographic location information for each data item (e.g., GPS coordinates, region codes, facility IDs), data collection time, submitter's regional attributes, and region-specific evaluation history (e.g., distribution of evaluation scores by region, bias indicators). The evaluation unit inputs these geographic data into the AI module as numerical vectors (e.g., latitude and longitude), categorical data (e.g., region codes), and historical matrices (e.g., region×evaluation score). Examples of AI inputs include: (1) GPS coordinates and evaluation scores for each data item, (2) region-specific evaluation bias indicators, and (3) region-specific evaluation history matrices. The evaluation unit inputs these data into a geospatial recognition AI (e.g., Transformer-based location information processing model or graph neural network), and the AI outputs (a) region-specific evaluation criteria optimization parameters (e.g., weighting according to regional characteristics), (b) bias correction coefficients (e.g., correction values for each region), and (c) region-specific evaluation results (e.g., reliability scores for each region). For example, the AI automatically generates specific evaluation policies such as “apply correction values if evaluation bias is high in a specific region” or “automatically adjust evaluation criteria between urban and rural areas.” These AI outputs are used in subsequent evaluation execution modules for applying region-specific evaluation criteria, bias correction, and region-specific aggregation of evaluation results. Conventional human consideration of geographic distribution and bias elimination made it difficult to reflect vast regional data in real time, but the evaluation unit achieves significant technical effects by performing automatic regional optimization, bias correction, and evaluation criteria optimization in high-dimensional geospatial data using AI, greatly improving evaluation accuracy, fairness, and regional adaptability. Application fields include regional information evaluation in smart cities, region-specific diagnostic support in medical settings, regional service evaluation for public transportation, and site-specific quality control evaluation in factories. Furthermore, for AI model training, past geographic distribution data, evaluation results, user feedback, and region-specific anomaly history are used, and weight optimization is performed based on loss functions (e.g., maximizing evaluation accuracy, minimizing bias), enabling continuous improvement in accuracy and enhanced environmental adaptability. Thus, the present invention fundamentally improves the efficiency, accuracy, and fairness of geoinformation-linked evaluation in computer technology itself, going beyond mere automation of human tasks.

The evaluation unit can refer to related literature of the data during evaluation to improve evaluation accuracy. For example, the evaluation unit improves evaluation accuracy based on related literature of the data. Furthermore, the evaluation unit can eliminate evaluation bias by referring to related literature. Additionally, the evaluation unit can analyze related literature to improve the reliability of evaluation. Thus, by referring to related literature of the data, evaluation accuracy is improved. Some or all of the above-described processes in the evaluation unit may be performed using AI, or may be performed without using AI. For example, the evaluation unit can input related literature of the data into a generative AI and have the generative AI execute the evaluation. Specifically, the evaluation unit maintains a structured database of literature information related to the evaluation target data (e.g., paper title, author, publication year, abstract, keywords), reliability scores of literature, citation counts, field classification, and past evaluation history (e.g., literature reference counts, evaluation scores). The evaluation unit inputs these literature data into the AI module as text vectors (e.g., abstract embeddings), numerical vectors (e.g., reliability scores, citation counts), and categorical data (e.g., field IDs). Examples of AI inputs include: (1) evaluation target data and summary of related literature, (2) reliability scores and citation counts for each literature, and (3) evaluation history by field classification. The evaluation unit inputs these data into a natural language processing AI (e.g., BERT or large language models) or multimodal generative AI, and the AI outputs (a) similarity scores between evaluation target data and literature (real values from 0.0 to 1.0), (b) evaluation correction values based on literature reference, and (c) proposals for improving evaluation reliability (e.g., recommendation to refer to additional literature). For example, the AI automatically generates specific evaluation policies such as “add reliability if highly similar literature exists for the evaluation target data” or “refer to literature from different fields if bias is suspected.” These AI outputs are used in subsequent evaluation execution modules for evaluation correction and reliability improvement through literature reference and bias elimination. Conventional human literature reference and bias elimination made it difficult to reflect vast literature information in real time, but the evaluation unit achieves significant technical effects by performing automatic similarity judgment, evaluation correction, and reliability improvement in high-dimensional literature data space using AI, greatly improving evaluation accuracy, reliability, and fairness. Application fields include peer review support for academic papers, evidence evaluation of medical diagnostic data, operation information evaluation for public transportation, and quality control data evaluation in factories. Furthermore, for AI model training, past literature data, evaluation results, user feedback, and response history during anomalies are used, and weight optimization is performed based on loss functions (e.g., maximizing evaluation accuracy, minimizing bias), enabling continuous improvement in accuracy and enhanced environmental adaptability. Thus, the present invention fundamentally improves the efficiency, accuracy, and reliability of literature-linked evaluation in computer technology itself, going beyond mere automation of human tasks.

The provision unit can estimate a user's emotion and adjust the method of information provision based on the estimated emotion of the user. For example, if the user is nervous, the provision unit provides a simple and highly visible information provision method. Furthermore, if the user is relaxed, the provision unit can provide a detailed information provision method. Additionally, if the user is in a hurry, the provision unit can provide an information provision method that emphasizes key points. Thus, by adjusting the method of information provision according to the user's emotion, information that is easy for the user to understand can be provided. Emotion estimation is realized, for example, by using an emotion engine or generative AI with emotion estimation functionality. Generative AI may include text generation AI (e.g., LLM) or multimodal generative AI, but is not limited to these examples. Some or all of the above-described processes in the provision unit may be performed using AI, or may be performed without using AI. For example, the provision unit can input the user's emotion data into a generative AI and have the generative AI adjust the method of information provision. Specifically, the provision unit acquires in real time the user's biometric sensor data (e.g., one-minute time-series vector of heart rate, one-dimensional array of skin conductance), sequence of facial image frames (e.g., 10 frames, each 128×128 pixels), voice waveform data (e.g., one-dimensional array of 160,000 values over 10 seconds), and text chat history (e.g., strings such as “I'm nervous today”), and inputs these, after preprocessing (e.g., noise removal, normalization, feature extraction), into a multimodal emotion estimation AI (e.g., Transformer-based multimodal model). The provision unit obtains from the AI (a) emotion labels (e.g., “nervous,” “relaxed,” “in a hurry,” etc.), (b) emotion intensity scores (real values from 0.0 to 1.0), and (c) confidence scores for emotion estimation (real values from 0.0 to 1.0). For example, if the heart rate is high and the facial image shows a furrowed brow, a “nervous” label and high intensity score are output. If features of fast speech or high pitch are extracted from the voice waveform, an “in a hurry” label is output. Based on these AI outputs, the provision unit automatically determines the expression format of the information provision method. For example, if the “nervous” label and intensity score are 0.7 or higher, the information is displayed concisely in bullet points with calm colors. If the “relaxed” label is present, detailed graphs and supplementary explanations are generated. If “in a hurry,” a short summary emphasizing key points is generated. Examples of AI inputs include: (1) one-minute time-series data of heart rate (60 values), (2) facial image frames (10 frames), (3) voice waveform data (160,000 values), and (4) text chat history (e.g., “I'm nervous today”). Examples of AI outputs include: (1) emotion label “nervous,” intensity 0.8, confidence 0.9; (2) emotion label “relaxed,” intensity 0.3, confidence 0.95; (3) emotion label “in a hurry,” intensity 0.7, confidence 0.85. These outputs are used in subsequent information provision generation modules for branching expression methods (e.g., detailed display/simple display/key point display) and UI layout optimization (e.g., font size, color scheme, presence of graphs). The provision unit achieves significant technical effects by realizing dynamic optimization of information provision methods according to the user's emotional state, which was difficult with conventional human information provision, through automatic emotion estimation and expression optimization in high-dimensional emotion data space using AI, greatly improving understanding, satisfaction, and user experience of information provision. Application fields include patient information provision in medical settings, learner-adaptive feedback in education, passenger guidance in public transportation, and stress monitoring systems. Furthermore, for AI model training, past emotion data, information provision history, user feedback, and behavioral history during anomalies are used, and weight optimization is performed based on loss functions (e.g., maximizing user understanding, minimizing misunderstanding rate), enabling continuous improvement in accuracy and enhanced environmental adaptability. Thus, the present invention fundamentally improves the efficiency, accuracy, and user adaptability of information provision in computer technology itself, going beyond mere automation of human tasks.

The provision unit can refer to the user's past operation history during information provision to select the optimal provision method. For example, the provision unit selects the optimal information provision method based on the user's past operation history. Furthermore, the provision unit can provide information provision methods tailored to the user's preferences by referring to past operation history. Additionally, the provision unit can analyze past operation history to eliminate bias in information provision. Thus, by referring to the user's past operation history, the optimal information provision method can be selected. Some or all of the above-described processes in the provision unit may be performed using AI, or may be performed without using AI. For example, the provision unit can input the user's past operation history into a generative AI and have the generative AI select the optimal provision method. Specifically, the provision unit maintains a structured database of the user's past operation history data (e.g., app launch history, notification viewing history, selection history of information provision formats, operation time, device type used for operation, user attribute information at the time of operation). The provision unit inputs these historical data into the AI module as time-series vectors (e.g., daily transition of notification viewing counts), categorical data (e.g., selection history of notification formats), and numerical matrices (e.g., viewing rate matrix for each notification format×each time slot). Examples of AI inputs include: (1) time-series data of notification viewing counts over the past 30 days (vector of 30 real values), (2) selection history for each notification format, and (3) selection rate of information provision formats by device type. The provision unit inputs these data into a Transformer-based time-series analysis model or multimodal generative AI, and the AI outputs (a) optimal information provision method (e.g., push notification, email notification, voice notification, etc.), (b) customization parameters based on user preferences (e.g., length of notification text, display timing), and (c) bias correction coefficients (e.g., correction values for bias toward specific formats). For example, the AI automatically generates specific provision method selection policies such as “prioritize push notifications if viewing rate is high for push notifications over the past 30 days” or “recommend email notifications at night.” These AI outputs are used in subsequent information provision generation modules for automatic selection of notification formats, text generation, and optimization of delivery timing. Conventional human analysis of operation history and provision method selection made it difficult to derive optimal solutions from vast historical data, but the provision unit achieves significant technical effects by performing automatic pattern extraction, optimization, and bias correction in high-dimensional historical data space using AI, greatly improving information provision efficiency, accuracy, and user satisfaction. Application fields include notification optimization for smartphone apps, patient information provision in medical settings, passenger guidance in public transportation, and promotional notifications in commercial facilities. Furthermore, for AI model training, past operation history data, provision results, user feedback, and response history during anomalies are used, and weight optimization is performed based on loss functions (e.g., maximizing notification viewing rate, minimizing unnecessary notifications), enabling continuous improvement in accuracy and enhanced environmental adaptability. Thus, the present invention fundamentally improves the efficiency, accuracy, and user adaptability of information provision optimization in computer technology itself, going beyond mere automation of human tasks.

The provision unit can customize the content of provision based on the user's current situation during information provision. For example, if the user is inside a train, the provision unit prioritizes broadcast content inside the train. Furthermore, if the user is within a facility, the provision unit can prioritize emergency broadcast content within the facility. Additionally, the provision unit can customize and provide necessary information based on the user's current situation. Thus, by customizing the content of provision based on the user's current situation, necessary information can be provided preferentially. Some or all of the above-described processes in the provision unit may be performed using AI, or may be performed without using AI. For example, the provision unit can input the user's current situation into a generative AI and have the generative AI execute customization of the provision content. Specifically, the provision unit acquires in real time the user's current location information (e.g., GPS coordinates, Wi-Fi beacon ID), movement history, device usage status (e.g., app launch history, screen operation logs), and user profile (e.g., field of interest tags, past information viewing history), and inputs these as structured data (e.g., attribute vectors in JSON format) into the AI module. Examples of AI inputs include: (1) location information vector when the current location is determined to be “inside a train,” (2) user profile with field of interest set to “disaster prevention” or “traffic information,” and (3) device usage status flag such as “voice guidance app is running.” The provision unit inputs these data into a multimodal generative AI (e.g., Transformer-based situation recognition model), and the AI outputs (a) information categories to be prioritized (e.g., “train broadcast,” “facility emergency broadcast,” “traffic delay information,” etc.), (b) customization results of provision content (e.g., text generation according to user situation), and (c) optimization parameters for provision frequency and timing (e.g., every 1 minute, every 5 minutes, etc.). For example, the AI automatically generates specific provision policies such as “if the user is inside a train and interested in disaster prevention, prioritize emergency broadcasts and congestion data” or “when staying in a facility, focus on providing evacuation route information.” These AI outputs are reflected in real time in subsequent information provision generation modules, enabling information provision optimized for user situation and field of interest. Conventional human judgment of situation and information customization made it difficult to achieve real-time and diverse data integration, but the provision unit achieves significant technical effects by performing automatic situation recognition, customization, and provision optimization in high-dimensional attribute space using AI, greatly improving information provision efficiency, accuracy, and user adaptability. Application fields include passenger support in public transportation, personalized information provision in commercial facilities, patient situation-adaptive notifications in medical settings, and environment control in smart homes. Furthermore, for AI model training, past situation data, provision results, user feedback, and information acquisition history by field of interest are used, and weight optimization is performed based on loss functions (e.g., maximizing necessary information provision rate, minimizing unnecessary information provision), enabling continuous improvement in accuracy and enhanced environmental adaptability. Thus, the present invention fundamentally improves the efficiency, accuracy, and user adaptability of information provision in computer technology itself, going beyond mere automation of human tasks.

The provision unit can estimate a user's emotion and determine the priority of information provision based on the estimated emotion of the user. For example, if the user is feeling stressed, the provision unit prioritizes only important information. Furthermore, if the user is relaxed, the provision unit can prioritize detailed information. Additionally, if the user is in an emergency situation, the provision unit can prioritize information with high urgency. Thus, by determining the priority of information provision according to the user's emotion, important information can be provided preferentially. Emotion estimation is realized, for example, by using an emotion engine or generative AI with emotion estimation functionality. Generative AI may include text generation AI (e.g., LLM) or multimodal generative AI, but is not limited to these examples. Some or all of the above-described processes in the provision unit may be performed using AI, or may be performed without using AI. For example, the provision unit can input the user's emotion data into a generative AI and have the generative AI determine the priority of information provision. Specifically, the provision unit acquires in real time the user's biometric sensor data (e.g., time-series vector of heart rate, one-dimensional array of skin conductance), sequence of facial image frames, voice waveform data, and text chat history, and inputs these, after preprocessing (e.g., noise removal, normalization, feature extraction), into the AI module. Examples of AI inputs include: (1) one-minute time-series data of heart rate (vector of 60 values), (2) ten-second voice waveform data (one-dimensional array of 160,000 values), (3) facial image frames (10 frames, each 128×128 pixels), and (4) text chat history (e.g., strings such as “I'm tired today”). The provision unit inputs these data into a Transformer-based multimodal emotion estimation model, and the AI outputs (a) emotion labels (e.g., “stress,” “relaxation,” “emergency,” etc.), (b) emotion intensity scores (real values from 0.0 to 1.0), and (c) confidence scores for emotion estimation (real values from 0.0 to 1.0). For example, if the heart rate is high and the facial image shows a furrowed brow, a “stress” label and high intensity score are output. If features of anger are extracted from the voice waveform, an “emergency” label is output. Based on these AI outputs, the information provision priority determination module automatically determines (a) a priority list of information to be provided (e.g., in emergencies, “safety information,” “evacuation routes,” etc. are prioritized), (b) timing of provision execution (e.g., during stress, only important information is provided immediately; during relaxation, detailed information is also provided), and (c) provision granularity (e.g., in emergencies, key points are provided; during relaxation, detailed information is provided). Thus, the system can prioritize important information according to the user's emotional state, achieving both reduced user burden and immediate acquisition of necessary information. Real-time emotion-adaptive information provision priority control, which was difficult with conventional human work or simple rule-based control, is realized by AI-based multimodal integration, automatic feature extraction, and threshold judgment, resulting in significant technical effects that greatly improve system efficiency, accuracy, and user experience. Application fields include wearable health management, stress monitoring, emergency notification systems, smart home environment control, and passenger support in public transportation. Furthermore, for AI model training, past biometric sensor data, emotion-labeled training data, user feedback, and behavioral history during anomalies are used, and weight optimization is performed based on loss functions (e.g., cross-entropy, MSE), enabling continuous improvement in accuracy and enhanced environmental adaptability. Thus, the present invention fundamentally improves the efficiency, accuracy, and user adaptability of information provision in computer technology itself, going beyond mere automation of human tasks.

The provision unit can select the optimal provision method by considering the user's device information during information provision. For example, if the user is using a smartphone, the provision unit provides an information provision method optimized for the screen size. Furthermore, if the user is using a tablet, the provision unit can provide an information provision method optimized for a larger screen. Additionally, if the user is using a smartwatch, the provision unit can provide a concise and highly visible information provision method. Thus, by considering the user's device information, the optimal information provision method can be selected. Some or all of the above-described processes in the provision unit may be performed using AI, or may be performed without using AI. For example, the provision unit can input the user's device information into a generative AI and have the generative AI select the optimal provision method. Specifically, the provision unit acquires in real time device information such as user terminal type (e.g., smartphone, tablet, smartwatch), screen size, resolution, OS type, battery level, and user attributes (e.g., hearing-impaired, visually impaired), and inputs these as structured data (e.g., attribute vectors in JSON format) into the AI module. Examples of AI inputs include: (1) terminal type “smartphone,” screen size 5.5 inches; (2) terminal type “tablet,” screen size 10 inches; (3) terminal type “smartwatch,” screen size 1.5 inches; (4) battery level 80%, etc. The provision unit inputs these data into a multimodal generative AI (e.g., Transformer-based device optimization model), and the AI outputs (a) optimal information provision format (e.g., “push notification,” “email notification,” “voice notification,” etc.), (b) automatic adjustment parameters for display layout (e.g., font size, number of display items), and (c) optimization of notification text length and content (e.g., switching between summary and detail according to screen size). For example, the AI automatically generates specific provision method selection policies such as “display only key points in large font on a smartwatch” or “display detailed information and graphs on a tablet.” These AI outputs are used in subsequent information provision generation modules for UI optimization and selection of notification delivery format for each device. Conventional human consideration of device information and provision method selection made it difficult to achieve real-time and multi-device support, but the provision unit achieves significant technical effects by performing automatic optimization, layout adjustment, and selection of provision format in high-dimensional device attribute space using AI, greatly improving information provision efficiency, accuracy, and user adaptability. Application fields include multi-device compatible information notification systems, patient device-optimized notifications in medical settings, passenger guidance in public transportation, and device-linked notifications in smart homes. Furthermore, for AI model training, past device usage data, provision results, user feedback, and information acquisition history by device are used, and weight optimization is performed based on loss functions (e.g., maximizing device adaptation rate, minimizing unnecessary notifications), enabling continuous improvement in accuracy and enhanced environmental adaptability. Thus, the present invention fundamentally improves the efficiency, accuracy, and user adaptability of information provision optimization in computer technology itself, going beyond mere automation of human tasks.

The provision unit can analyze the user's social media activity during information provision to adjust the content of provision. For example, if the user mentions a specific topic on social media, the provision unit provides information related to that topic. Furthermore, if the user participates in a specific event on social media, the provision unit can provide information related to that event. Additionally, the provision unit can analyze the user's social media activity to prioritize information of high interest. Thus, by analyzing the user's social media activity, information of high interest can be provided preferentially. Some or all of the above-described processes in the provision unit may be performed using AI, or may be performed without using AI. For example, the provision unit can input the user's social media activity data into a generative AI and have the generative AI adjust the content of provision. Specifically, the provision unit acquires in real time the user's social media posting history (e.g., text posts, image posts, video posts), posting time, posting location information, event participation information (e.g., event name, venue, participation date and time), and tags or hashtags attached to posts, and inputs these as structured data (e.g., post content vectors, tag lists, event IDs) into the AI module. Examples of AI inputs include: (1) posting text history for the past week (e.g., list of strings such as “I went to a new cafe,” “Participated in a disaster prevention event”), (2) list of hashtags attached to posts (e.g., “# traffic information,” “# event name”), and (3) metadata of participated events (e.g., event name, venue, date and time). The provision unit inputs these data into a natural language processing AI (e.g., BERT or large language models) or multimodal generative AI, and the AI outputs (a) results of extracting user interest topics (e.g., category labels such as “cafe,” “disaster prevention,” “traffic”), (b) information categories to be prioritized (e.g., notifications or event information related to interest topics), (c) list of target events for provision (e.g., event IDs scheduled for participation this week), and (d) optimization parameters for provision frequency and granularity (e.g., provide detailed information at high frequency for topics of high interest). For example, the AI automatically generates specific provision policies such as “prioritize disaster prevention information if the user frequently uses the # disaster prevention tag” or “focus on providing information about upcoming events based on event participation history.” These AI outputs are reflected in real time in subsequent information provision generation modules, enabling information provision optimized for the user's social media activity. Conventional human analysis of posts and interest estimation made it difficult to achieve real-time and diverse data integration, but the provision unit achieves significant technical effects by performing automatic interest extraction and provision optimization in high-dimensional posting data space using AI, greatly improving information provision efficiency, accuracy, and user adaptability. Application fields include personalized information provision, event guidance, disaster information distribution, and promotion optimization in commercial facilities. Furthermore, for AI model training, past posting data, provision results, user feedback, and event participation history are used, and weight optimization is performed based on loss functions (e.g., maximizing interest information provision rate, minimizing unnecessary information provision), enabling continuous improvement in accuracy and enhanced environmental adaptability. Thus, the present invention fundamentally improves the efficiency, accuracy, and user adaptability of social media-linked information provision in computer technology itself, going beyond mere automation of human tasks.

The system according to the embodiment is not limited to the above-described examples, and various modifications are possible, for example, as follows. Specifically, the system allows for diverse variations in AI model architecture and training methods, data flow, input/output specifications, and module configuration. For example, as the voice recognition AI module, not only Transformer-based models but also convolutional neural networks (CNN), recurrent neural networks (RNN), self-supervised learning models, lightweight models for edge devices, etc. can be adopted. For emotion estimation AI, expansion from single-modal (voice only, image only) to multimodal (voice+image+text+biometric sensor), introduction of supervised, semi-supervised, and reinforcement learning, and adoption of cloud-linked or distributed inference are possible. The configuration of the data collection unit and provision unit can also adapt to various network forms such as IoT sensor networks, 5G communication, local server linkage, and P2P communication between user terminals. Furthermore, as training data for AI models, combinations of public corpora, field-collected data, user feedback, behavioral history during anomalies, and simulation data can be used. Loss functions and optimization methods can also be selected from various approaches such as cross-entropy, MSE, focal loss, ensemble learning, and transfer learning. With these variations, the present invention exhibits technical effects that flexibly adapt to a wide range of application fields and operational environments without depending on specific AI models, hardware configurations, network environments, or data types. Application fields include smart buildings, medical settings, public transportation, factories, commercial facilities, smart homes, disaster response systems, and educational support systems. Thus, the present invention fundamentally improves the flexibility, scalability, and operational efficiency of computer technology itself, going beyond mere automation of human tasks.

The collection unit can monitor the user's health status and adjust the frequency of data collection based on the health status. For example, if the user is in poor physical condition, the frequency of data collection is reduced to lessen the user's burden. Furthermore, if the user is healthy, the frequency of data collection is increased to collect more detailed information. Additionally, if the user is exercising, exercise data can be collected preferentially. Thus, by adjusting the frequency of data collection according to the user's health status, the user's burden is reduced and necessary information can be efficiently collected. Specifically, the collection unit acquires in real time biometric and activity data from wearable devices or smartphones worn by the user, such as time-series vector of heart rate (e.g., 60 points per minute), one-dimensional array of blood oxygen saturation, time-series data of steps and acceleration sensor, label sequence of sleep state, and continuous values from temperature sensors. The collection unit preprocesses these data (e.g., noise removal, outlier correction, normalization) and inputs them into a health status estimation AI (e.g., Transformer-based multimodal health judgment model). Examples of AI inputs include: (1) one-minute time-series data of heart rate (vector of 60 values), (2) ten-minute time-series data of acceleration sensor (600 points), (3) label sequence of sleep state (e.g., “light,” “deep,” “awake”), and (4) continuous value of body temperature (e.g., 36.5° C.). The collection unit obtains from the AI (a) health status label (e.g., “healthy,” “poor physical condition,” “exercising”), (b) health risk score (real value from 0.0 to 1.0), and (c) recommended collection frequency (e.g., every 1 minute, every 10 minutes, every 1 hour). For example, the AI automatically generates specific collection policies such as “if heart rate is higher than at rest and acceleration sensor indicates exercising, collect exercise data at high frequency” or “reduce collection frequency during sleep or poor physical condition.” These AI outputs are reflected in real time in subsequent collection control modules, enabling information collection optimized for the user's health status. Conventional human health monitoring and collection frequency adjustment made it difficult to achieve real-time and multi-item simultaneous response, but the collection unit achieves significant technical effects by performing automatic health status estimation and collection optimization in high-dimensional biometric and activity data space using AI, greatly improving information collection efficiency, accuracy, and reduction of user burden. Application fields include wearable health management, rehabilitation support, sports training, patient monitoring in medical settings, and health monitoring in smart homes. Furthermore, for AI model training, past health status data, collection history, user feedback, and behavioral history during anomalies are used, and weight optimization is performed based on loss functions (e.g., maximizing health status estimation accuracy, minimizing unnecessary data collection), enabling continuous improvement in accuracy and enhanced environmental adaptability. Thus, the present invention fundamentally improves the efficiency, accuracy, and reduction of user burden in health status-linked data collection in computer technology itself, going beyond mere automation of human tasks.

The analysis unit can analyze the user's past behavioral patterns and determine the priority of analysis based on predicted behavior. For example, if the user commutes every morning, the analysis unit prioritizes analysis of data related to commuting time. Furthermore, the analysis unit can prioritize analysis of data related to places the user regularly visits. Additionally, the analysis unit can prioritize analysis of data related to predicted events based on the user's behavioral patterns. Thus, by determining the priority of analysis based on the user's past behavioral patterns, efficient analysis becomes possible. Specifically, the analysis unit maintains structured data such as the user's location history (e.g., time-series vector of GPS coordinates), public transportation usage history, app launch history, calendar events, and past notification viewing history, and inputs these into a time-series analysis AI (e.g., Transformer-based behavior prediction model or LSTM network). Examples of AI inputs include: (1) time-series data of commuting routes over the past 30 days (e.g., movement patterns from 8:00 to 9:00 every morning), (2) list of regularly visited places (e.g., workplace, gym, supermarket), (3) time and location information of calendar events, and (4) time-series vector of notification viewing history. The analysis unit obtains from the AI (a) label of predicted next behavior (e.g., “commuting,” “returning home,” “shopping”), (b) probability of behavior occurrence (real value from 0.0 to 1.0), and (c) priority list for analysis (e.g., prioritize commuting time data). For example, the AI automatically generates specific analysis policies such as “prioritize analysis of commuting-related data during weekday mornings” or “prioritize analysis of shopping-related data on weekends.” These AI outputs are used in subsequent analysis execution modules for automatic determination of analysis order and optimization of resource allocation (e.g., allocation of GPU computational resources). Conventional human analysis of behavioral patterns and priority determination made it difficult to optimize in real time for vast historical data, but the analysis unit achieves significant technical effects by performing automatic behavior prediction and priority optimization in high-dimensional behavioral history data space using AI, greatly improving analysis efficiency, accuracy, and user adaptability. Application fields include personalized information analysis in smart cities, commuting support systems, visit prediction in commercial facilities, and patient behavior monitoring in medical settings. Furthermore, for AI model training, past behavioral history, analysis results, user feedback, and response history during events are used, and weight optimization is performed based on loss functions (e.g., maximizing behavior prediction accuracy, minimizing unnecessary analysis), enabling continuous improvement in accuracy and enhanced environmental adaptability. Thus, the present invention fundamentally improves the efficiency, accuracy, and user adaptability of behavior prediction-linked analysis in computer technology itself, going beyond mere automation of human tasks.

The evaluation unit can perform evaluation by considering the user's social background. For example, the evaluation criteria are adjusted based on the user's cultural background and language. Furthermore, the evaluation method can be customized based on the user's occupation and education level. Additionally, the evaluation unit can eliminate evaluation bias according to the user's social background. Thus, by considering the user's social background, fairer and more accurate evaluation becomes possible. Specifically, the evaluation unit maintains a structured database of user attributes such as cultural area ID, native language, language used, occupation code, education level, residential area, past evaluation history (e.g., evaluation scores, history of applied evaluation criteria), and bias indicators for each attribute. The evaluation unit inputs these attribute data into the AI module as categorical vectors (e.g., cultural area ID, language code, occupation code), numerical vectors (e.g., education level score), and historical matrices (e.g., evaluation criteria×user attributes). Examples of AI inputs include: (1) user's cultural area ID and native language, (2) occupation code and education level score, and (3) past evaluation history and bias indicator matrix. The evaluation unit inputs these data into a Transformer-based attribute-adaptive evaluation model or multimodal generative AI, and the AI outputs (a) optimal evaluation criteria parameters (e.g., weighting by cultural area, language adaptation coefficient), (b) bias correction coefficients (e.g., correction values for each attribute), and (c) proposals for automatic customization of evaluation methods (e.g., adjustment of explanation granularity according to education level). For example, the AI automatically generates specific evaluation policies such as “automatically translate evaluation explanation text if native language differs” or “apply detailed evaluation criteria if education level is high.” These AI outputs are used in subsequent evaluation execution modules for automatic adjustment of evaluation criteria, bias correction, and customization of evaluation explanations. Conventional human consideration of social background and bias elimination made it difficult to reflect vast attribute information in real time, but the evaluation unit achieves significant technical effects by performing automatic adaptation, bias correction, and evaluation criteria optimization in high-dimensional attribute data space using AI, greatly improving evaluation accuracy, fairness, and reliability. Application fields include multilingual evaluation for global services, grading in education, patient attribute-adaptive evaluation in medical settings, and multicultural evaluation in public transportation. Furthermore, for AI model training, past attribute data, evaluation results, user feedback, and response history during anomalies are used, and weight optimization is performed based on loss functions (e.g., maximizing evaluation accuracy, minimizing bias), enabling continuous improvement in accuracy and enhanced environmental adaptability. Thus, the present invention fundamentally improves the efficiency, accuracy, and fairness of social background-adaptive evaluation in computer technology itself, going beyond mere automation of human tasks.

The provision unit can adjust the method of information provision by considering the battery level of the user's device. For example, if the battery level is low, a concise and power-saving information provision method is selected. Furthermore, if the battery level is sufficient, detailed information can be provided. Additionally, the frequency of information provision can be adjusted according to the battery level. Thus, by considering the battery level of the user's device, efficient information provision becomes possible. Specifically, the provision unit acquires in real time the battery level of the user's device (e.g., percentage value), device type (e.g., smartphone, tablet, smartwatch), screen brightness setting, communication mode (e.g., power-saving mode, normal mode), and past battery consumption history, and inputs these as structured data (e.g., attribute vectors) into the AI module. Examples of AI inputs include: (1) smartphone with 20% battery level, (2) tablet with power-saving mode ON, (3) battery consumption history vector (past 24 hours), etc. The provision unit inputs these data into a device optimization AI (e.g., Transformer-based battery adaptation model), and the AI outputs (a) optimal information provision format (e.g., text only, omit images, turn off voice notifications, etc.), (b) optimization parameters for provision frequency (e.g., every hour if battery level is below 20%, every 5 minutes if above 80%), and (c) instructions for simplifying or detailing notification content. For example, the AI automatically generates specific provision method selection policies such as “display only key points in large font if battery level is below 10%” or “display detailed information and graphs if battery level is sufficient.” These AI outputs are used in subsequent information provision generation modules for UI optimization, selection of notification delivery format for each device, and control of provision frequency. Conventional human consideration of battery level and provision method selection made it difficult to achieve real-time and multi-device support, but the provision unit achieves significant technical effects by performing automatic optimization, layout adjustment, and control of provision frequency in high-dimensional device attribute space using AI, greatly improving information provision efficiency, accuracy, user adaptability, and power-saving performance. Application fields include information notification systems for mobile devices, patient device-optimized notifications in medical settings, passenger guidance in public transportation, and device-linked notifications in smart homes. Furthermore, for AI model training, past device usage data, provision results, user feedback, and battery consumption history are used, and weight optimization is performed based on loss functions (e.g., maximizing device adaptation rate, minimizing unnecessary notifications, maximizing power-saving performance), enabling continuous improvement in accuracy and enhanced environmental adaptability. Thus, the present invention fundamentally improves the efficiency, accuracy, user adaptability, and power-saving performance of information provision optimization in computer technology itself, going beyond mere automation of human tasks.

The provision unit can refer to the user's schedule to adjust the timing of information provision. For example, if the user is in a meeting, information is provided after the meeting ends. Furthermore, if the user is in transit, information can be provided after the transit is completed. Additionally, the optimal timing of information provision can be selected based on the user's schedule. Thus, by considering the user's schedule, information can be provided at an appropriate timing. Specifically, the provision unit maintains a structured database of the user's calendar events (e.g., meetings, business trips, breaks), scheduled times, event types, planned movements, and past information provision history (e.g., notification receipt times and viewing rates), and inputs these as time-series vectors and categorical data into the AI module. Examples of AI inputs include: (1) meeting scheduled today from 9:00 to 10:00, (2) planned movement from 10:00 to 10:30, (3) time-series vector of notification receipt and viewing history over the past 30 days, etc. The provision unit inputs these data into a time-series analysis AI (e.g., Transformer-based schedule adaptation model), and the AI outputs (a) optimal timing for information provision (e.g., immediately after meeting ends, after transit is completed), (b) priority list of notification content (e.g., order according to urgency and interest), and (c) optimization parameters for timing (e.g., notification interval, re-notification timing). For example, the AI automatically generates specific timing selection policies such as “suppress notifications during meetings and provide them collectively after the meeting” or “provide only key points concisely during transit.” These AI outputs are used in subsequent information provision generation modules for automatic adjustment of notification delivery timing and prioritization of content. Conventional human consideration of schedules and adjustment of notification timing made it difficult to achieve real-time and multi-event simultaneous response, but the provision unit achieves significant technical effects by performing automatic timing optimization and priority control in high-dimensional schedule data space using AI, greatly improving information provision efficiency, accuracy, and user satisfaction. Application fields include schedule-linked notifications for business persons, patient schedule-adaptive notifications in medical settings, passenger guidance in public transportation, and learner schedule-linked information provision in education. Furthermore, for AI model training, past schedule data, provision results, user feedback, and notification viewing history are used, and weight optimization is performed based on loss functions (e.g., maximizing notification viewing rate, minimizing unnecessary notifications, optimizing timing), enabling continuous improvement in accuracy and enhanced environmental adaptability. Thus, the present invention fundamentally improves the efficiency, accuracy, and user adaptability of information provision timing optimization in computer technology itself, going beyond mere automation of human tasks.

The collection unit can estimate a user's emotion and customize the content of data collection based on the estimated emotion of the user. For example, if the user is feeling stressed, the collection unit prioritizes collection of environmental data that can help the user relax. Furthermore, if the user is excited, the collection unit can collect data to help calm the excitement. Additionally, if the user is sad, the collection unit can collect data to help improve the mood. Thus, by customizing the content of data collection according to the user's emotion, information provision that is attentive to the user's emotion becomes possible. Specifically, the collection unit acquires in real time the user's biometric sensor data (e.g., time-series vector of heart rate, skin conductance), sequence of facial image frames, voice waveform data, and text chat history, and inputs these, after preprocessing (e.g., noise removal, normalization, feature extraction), into a multimodal emotion estimation AI (e.g., Transformer-based multimodal model). The collection unit obtains from the AI (a) emotion labels (e.g., “stress,” “excitement,” “sadness,” etc.), (b) emotion intensity scores, and (c) confidence scores for emotion estimation. For example, if the “stress” label and intensity score are high, the collection unit prioritizes collection of relaxation environment data (e.g., quiet area audio, comfortable temperature and humidity data, natural environment images). If the “excitement” label is present, the collection unit collects environment data expected to have a calming effect (e.g., soothing music, low-light images). If the “sadness” label is present, the collection unit collects data to help improve mood (e.g., images with bright colors, positive text, etc.). These AI outputs are reflected in real time in subsequent collection control modules, enabling information collection optimized for the user's emotional state. Conventional human emotion estimation and customization of collection content made it difficult to achieve real-time and multimodal integration, but the collection unit achieves significant technical effects by performing automatic emotion estimation and optimization of collection content in high-dimensional emotion data space using AI, greatly improving information collection efficiency, accuracy, and user adaptability. Application fields include wearable health management, stress monitoring, emotion-adaptive data collection for patients in medical settings, and emotion-linked information collection for learners in education. Furthermore, for AI model training, past emotion data, collection results, user feedback, and behavioral history during anomalies are used, and weight optimization is performed based on loss functions (e.g., maximizing emotion adaptation rate, minimizing unnecessary data collection), enabling continuous improvement in accuracy and enhanced environmental adaptability. Thus, the present invention fundamentally improves the efficiency, accuracy, and user adaptability of emotion-adaptive data collection in computer technology itself, going beyond mere automation of human tasks.

The analysis unit can estimate a user's emotion and adjust the presentation method of analysis results based on the estimated emotion of the user. For example, if the user is nervous, the analysis unit provides simple and highly visible analysis results. Furthermore, if the user is relaxed, the analysis unit can provide detailed analysis results. Additionally, if the user is in a hurry, the analysis unit can provide analysis results that emphasize key points. Thus, by adjusting the presentation method of analysis results according to the user's emotion, analysis results that are easy for the user to understand can be provided. Specifically, the analysis unit acquires in real time the user's biometric sensor data (e.g., one-minute time-series vector of heart rate, skin conductance), sequence of facial image frames, voice waveform data, and text chat history, and inputs these, after preprocessing (e.g., noise removal, normalization, feature extraction), into a multimodal emotion estimation AI (e.g., Transformer-based multimodal model). The analysis unit obtains from the AI (a) emotion labels (e.g., “nervous,” “relaxed,” “in a hurry,” etc.), (b) emotion intensity scores, and (c) confidence scores for emotion estimation. For example, if the “nervous” label and intensity score are 0.7 or higher, the analysis results are displayed concisely in bullet points with calm colors. If the “relaxed” label is present, analysis results with detailed graphs and supplementary explanations are generated. If “in a hurry,” a short summary emphasizing key points is generated. Examples of AI inputs include: (1) one-minute time-series data of heart rate (60 values), (2) facial image frames (10 frames), (3) voice waveform data (160,000 values), and (4) text chat history (e.g., “I'm nervous today”). Examples of AI outputs include: (1) emotion label “nervous,” intensity 0.8, confidence 0.9; (2) emotion label “relaxed,” intensity 0.3, confidence 0.95; (3) emotion label “in a hurry,” intensity 0.7, confidence 0.85. These outputs are used in subsequent analysis result generation modules for branching expression methods and UI layout optimization. Conventional human presentation of analysis results made it difficult to dynamically optimize expression according to the user's emotional state, but the analysis unit achieves significant technical effects by performing automatic emotion estimation and expression optimization in high-dimensional emotion data space using AI, greatly improving understanding, satisfaction, and user experience of analysis results. Application fields include patient-oriented analysis result presentation in medical settings, learner-adaptive feedback in education, passenger guidance in public transportation, and stress monitoring systems. Furthermore, for AI model training, past emotion data, analysis result presentation history, user feedback, and behavioral history during anomalies are used, and weight optimization is performed based on loss functions (e.g., maximizing user understanding, minimizing misunderstanding rate), enabling continuous improvement in accuracy and enhanced environmental adaptability. Thus, the present invention fundamentally improves the efficiency, accuracy, and user adaptability of analysis result presentation in computer technology itself, going beyond mere automation of human tasks.

The evaluation unit can estimate a user's emotion and adjust the evaluation criteria based on the estimated emotion of the user. For example, if the user is feeling stressed, the evaluation criteria are relaxed. Furthermore, if the user is relaxed, strict evaluation criteria can be applied. Additionally, if the user is excited, evaluation criteria to help calm the emotion can be applied. Thus, by adjusting the evaluation criteria according to the user's emotion, appropriate evaluation for the user can be performed. Specifically, the evaluation unit acquires in real time the user's biometric sensor data (e.g., time-series vector of heart rate, skin conductance), sequence of facial image frames, voice waveform data, and text chat history, and inputs these, after preprocessing (e.g., noise removal, normalization, feature extraction), into a multimodal emotion estimation AI (e.g., Transformer-based multimodal model). The evaluation unit obtains from the AI (a) emotion labels (e.g., “stress,” “relaxation,” “excitement,” etc.), (b) emotion intensity scores, and (c) confidence scores for emotion estimation. For example, if the “stress” label and intensity score are high, the evaluation criteria are relaxed to reduce user burden. If the “relaxation” label is present, strict evaluation criteria are applied for detailed evaluation. If the “excitement” label is present, evaluation criteria to help calm the emotion (e.g., emphasis on positive feedback) are applied. Examples of AI inputs include: (1) one-minute time-series data of heart rate (60 values), (2) facial image frames (10 frames), (3) voice waveform data (160,000 values), and (4) text chat history (e.g., “I'm feeling a lot of stress today”). Examples of AI outputs include: (1) emotion label “stress,” intensity 0.8, confidence 0.9; (2) emotion label “relaxation,” intensity 0.3, confidence 0.95; (3) emotion label “excitement,” intensity 0.7, confidence 0.85. These outputs are used in subsequent evaluation criteria adjustment modules for automatic switching of evaluation criteria and optimization of evaluation granularity. Conventional human emotion estimation and adjustment of evaluation criteria made it difficult to achieve real-time and multimodal integration, but the evaluation unit achieves significant technical effects by performing automatic emotion estimation and optimization of evaluation criteria in high-dimensional emotion data space using AI, greatly improving evaluation efficiency, accuracy, and user adaptability. Application fields include patient-oriented evaluation in medical settings, learner-adaptive evaluation in education, passenger guidance in public transportation, and stress monitoring systems. Furthermore, for AI model training, past emotion data, evaluation results, user feedback, and behavioral history during anomalies are used, and weight optimization is performed based on loss functions (e.g., maximizing evaluation accuracy, minimizing user burden), enabling continuous improvement in accuracy and enhanced environmental adaptability. Thus, the present invention fundamentally improves the efficiency, accuracy, and user adaptability of emotion-adaptive evaluation in computer technology itself, going beyond mere automation of human tasks.

The provision unit is capable of estimating a user's emotion and adjusting the frequency of information provision based on the estimated emotion of the user. For example, if the user is feeling stressed, the frequency of information provision is reduced to alleviate the user's burden. If the user is relaxed, the frequency of information provision is increased to provide more detailed information. Furthermore, if the user is in an emergency situation, the frequency of information provision is maximized to enable prompt response. By adjusting the frequency of information provision according to the user's emotion, the user's burden can be alleviated and necessary information can be efficiently provided. Specifically, the provision unit acquires, in real time, the user's biometric sensor data (e.g., time-series vector of heart rate, skin conductance response), a sequence of facial image frames, voice waveform data, text chat history, and the like, performs preprocessing (e.g., noise removal, normalization, feature extraction), and inputs these to a multimodal emotion estimation AI (e.g., Transformer-based multimodal model). The provision unit obtains from the AI (a) emotion labels (e.g., “stress,” “relaxation,” “emergency,” etc.), (b) emotion intensity scores, and (c) confidence scores for emotion estimation. For example, if the label is “stress” and the intensity score is high, the frequency of information provision is reduced to alleviate the user's burden. If the label is “relaxation,” the frequency of information provision is increased to provide more detailed information. If the label is “emergency,” the frequency of information provision is maximized and immediate notification is performed. Examples of AI input include (1) one-minute time-series heart rate data (60 points), (2) facial image frames (10 frames), (3) voice waveform data (160,000 points), and (4) text chat history (e.g., “Today is an emergency”). Examples of AI output include (1) emotion label “stress,” intensity 0.8, confidence 0.9; (2) emotion label “relaxation,” intensity 0.3, confidence 0.95; (3) emotion label “emergency,” intensity 0.9, confidence 0.95, and so on. These outputs are used by the subsequent information provision frequency control module to determine notification delivery intervals and immediate notification decisions. Conventional human-based emotion estimation and adjustment of information provision frequency have difficulty with real-time and multimodal integration, but the present provision unit achieves automatic emotion estimation and frequency optimization in a high-dimensional emotion data space using AI, thereby providing significant technical effects in improving information provision efficiency, accuracy, and reduction of user burden. Application fields include wearable health management, stress monitoring, emergency notification systems, smart home environmental control, and passenger support in public transportation. Furthermore, for AI model training, past emotion data and information provision history, user feedback, behavioral history during abnormal events, and the like are used, and weight optimization is performed based on loss functions (e.g., minimization of user burden, maximization of information provision efficiency), enabling continuous improvement of accuracy and enhancement of environmental adaptability. Thus, the present invention not only automates human tasks, but fundamentally improves emotion-adaptive information provision efficiency, accuracy, and reduction of user burden in computer technology itself.

The provision unit is capable of estimating a user's emotion and customizing the content of information provision based on the estimated emotion of the user. For example, if the user is feeling stressed, information that helps the user relax is provided. If the user is excited, information to calm the excitement can be provided. Furthermore, if the user is feeling sad, information to improve the mood can also be provided. By customizing the content of information provision according to the user's emotion, it becomes possible to provide information that is tailored to the user's emotional state. Specifically, the provision unit acquires, in real time, the user's biometric sensor data (e.g., time-series vector of heart rate, skin conductance response), a sequence of facial image frames, voice waveform data, text chat history, and the like, performs preprocessing (e.g., noise removal, normalization, feature extraction), and inputs these to a multimodal emotion estimation AI (e.g., Transformer-based multimodal model). The provision unit obtains from the AI (a) emotion labels (e.g., “stress,” “excitement,” “sadness,” etc.), (b) emotion intensity scores, and (c) confidence scores for emotion estimation. For example, if the label is “stress” and the intensity score is high, information expected to have a relaxing effect (e.g., nature sounds, soothing images, relaxation guides, etc.) is preferentially provided. If the label is “excitement,” information expected to have a calming effect (e.g., calm music, breathing guides, etc.) is provided. If the label is “sadness,” information that contributes to mood improvement (e.g., positive messages, images with bright colors, etc.) is provided. Examples of AI input include (1) one-minute time-series heart rate data (60 points), (2) facial image frames (10 frames), (3) voice waveform data (160,000 points), and (4) text chat history (e.g., “I am sad today”). Examples of AI output include (1) emotion label “stress,” intensity 0.8, confidence 0.9; (2) emotion label “excitement,” intensity 0.7, confidence 0.85; (3) emotion label “sadness,” intensity 0.6, confidence 0.9, and so on. These outputs are used by the subsequent information provision generation module for automatic customization of content and optimization of expression format. Conventional human-based emotion estimation and content customization of information provision have difficulty with real-time and multimodal integration, but the present provision unit achieves automatic emotion estimation and content optimization in a high-dimensional emotion data space using AI, thereby providing significant technical effects in improving information provision efficiency, accuracy, and user adaptability. Application fields include wearable health management, stress monitoring, emotion-adaptive information provision for patients in medical settings, and emotion-linked information provision for learners in the education field. Furthermore, for AI model training, past emotion data and information provision history, user feedback, behavioral history during abnormal events, and the like are used, and weight optimization is performed based on loss functions (e.g., maximization of emotion adaptation rate, minimization of unnecessary information provision), enabling continuous improvement of accuracy and enhancement of environmental adaptability. Thus, the present invention not only automates human tasks, but fundamentally improves emotion-adaptive information provision efficiency, accuracy, and user adaptability in computer technology itself.

Below, the processing flow of Example of the Embodiment is briefly described. Specifically, the present system operates with each module—the collection unit, analysis unit, evaluation unit, and provision unit—working in coordination, and automation and optimization processing by AI models are realized at each stage. First, the collection unit acquires diverse data (e.g., time-series sensor data, image frames, voice waveforms, text data, location information, biometric information, etc.) in real time from temperature sensors, humidity sensors, voice sensors, surveillance cameras, user terminals, wearable devices, IoT sensors, and the like, and inputs these as structured data (e.g., vectors, tensors, attribute lists) to the AI module. Next, the analysis unit inputs the data received from the collection unit into data category classification AI, multimodal generation AI, time-series analysis AI, and the like, and performs multi-stage analysis such as category determination, importance determination, emotion estimation, behavior prediction, and anomaly detection. The analysis unit automatically determines analysis priorities, level of detail, algorithm selection, and expression methods based on AI outputs (e.g., category labels, importance scores, emotion labels, anomaly scores, etc.). The evaluation unit inputs the filtered information and analysis results from the analysis unit into attribute-adaptive evaluation AI and bias correction AI, and performs multifaceted evaluation considering user attributes, emotions, social background, geographic distribution, past history, related literature, and so on. The evaluation unit automatically generates and optimizes evaluation results based on AI outputs (e.g., evaluation scores, confidence, bias correction values, evaluation criterion adjustment parameters, etc.). The provision unit performs optimization processing by AI considering information from the evaluation unit, user terminal type, battery level, schedule, emotional state, operation history, geographic location, and so on, and provides information to the user in real time in various formats such as push notifications, email notifications, voice notifications, and screen displays. Data flow between modules is efficiently coordinated via structured databases, message queues, API integration, and the like. These AI processes are executed on parallel computing clusters using GPUs, lightweight models on edge devices, cloud-linked inference platforms, and so on. Multimodal, multi-attribute, real-time, and personalized optimization, which was difficult with conventional human tasks or simple rule-based processing, is realized by automatic feature extraction, determination, and optimization in high-dimensional data spaces by AI, thereby providing significant technical effects in improving overall system efficiency, accuracy, scalability, and user adaptability. Application fields include smart buildings, medical settings, public transportation, factories, commercial facilities, smart homes, disaster response systems, and educational support systems. Furthermore, for AI model training, past data and analysis, evaluation, and provision history, user feedback, response history during abnormal events, and the like are used, and weight optimization is performed based on loss functions (e.g., maximization of accuracy, minimization of misjudgment, maximization of user satisfaction), enabling continuous improvement of accuracy and enhancement of environmental adaptability. Thus, the present invention not only automates human tasks, but fundamentally improves multi-stage information processing efficiency, accuracy, and user adaptability in computer technology itself.

Step 1: The collection unit collects data. The data includes sensor data, text data, voice data, and the like. The collection unit collects data using a temperature sensor, a humidity sensor, a voice sensor, and a surveillance camera. The temperature sensors and humidity sensors have multiple types with different measurement ranges and accuracy, and are selected according to specific environments. The voice sensors have different types with varying sensitivity and frequency ranges, and are used to detect specific sounds. The surveillance cameras have different types with varying resolution and field of view, and are used to monitor specific areas. Specifically, the collection unit acquires data obtained from these sensors (e.g., one-minute time-series vector from a temperature sensor, continuous values from a humidity sensor, ten-second waveform data from a voice sensor, a sequence of image frames from a surveillance camera) in real time, performs preprocessing (e.g., noise removal, normalization, feature extraction), and inputs the data as structured data (e.g., numerical vectors, image tensors, voice spectrograms, text token sequences) to the AI module. Step 2: The analysis unit analyzes the data collected by the collection unit using a generative AI and filters important information. Important information is filtered based on threshold settings or specific keywords. The generative AI uses a text generation AI (for example, LLM) to analyze the collected data and extract important information. In addition, the generative AI can integrate and analyze multiple data modalities using a multimodal generative AI. Specifically, the analysis unit inputs the collected data into a data category classification AI (e.g., Transformer-based multimodal classification model), anomaly detection AI, natural language processing AI, and the like, and outputs (a) data category labels (e.g., “temperature,” “voice,” “image,” “text,” etc.), (b) importance scores (e.g., 0.0 to 1.0), and (c) extracted important information (e.g., anomaly detection results, keyword extraction results, etc.). Examples of AI input include (1) one-minute time-series data from a temperature sensor (60 points), (2) voice waveform data (160,000 points), (3) image frames (1920×1080 pixels), and (4) text data (e.g., “Next is Shinjuku”). Examples of AI output include (1) category “temperature,” importance 0.9, anomaly detection “high temperature”; (2) category “voice,” importance 0.7, keyword “emergency,” and so on. These outputs are used by the subsequent filtering module to extract only important information through threshold determination and keyword matching, thereby improving analysis efficiency and accuracy. Step 3: The evaluation unit provides evaluation support based on the information filtered by the analysis unit. Evaluation support is performed based on evaluation algorithms and evaluation items. The evaluation unit uses AI to evaluate the filtered information and provide useful information to the user. Specifically, the evaluation unit inputs the information into attribute-adaptive evaluation AI and bias correction AI, considering user attributes, past evaluation history, geographic distribution, related literature, and so on, and outputs (a) evaluation scores, (b) confidence, and (c) bias correction values. Examples of AI output include evaluation score 0.85, confidence 0.9, bias correction value −0.05, and so on. These outputs are used by the subsequent evaluation result generation module to automatically generate optimal evaluation results for the user. Step 4: The provision unit provides the information obtained by the evaluation unit to the user in real time. The provision unit sends notifications to a smartphone or tablet so that the user can immediately obtain necessary information. Notifications are provided in formats such as push notifications and email notifications. Specifically, the provision unit performs optimization processing by AI considering user terminal type, battery level, schedule, emotional state, operation history, and so on, and automatically determines (a) the optimal notification format (e.g., push notification, email notification, voice notification), (b) the length and content of the notification message, and (c) the delivery timing, and provides information to the user terminal in real time. Through these multi-stage AI processes, multimodal, multi-attribute, real-time, and personalized optimization, which was difficult with conventional human tasks or simple rule-based processing, is realized, thereby providing significant technical effects in improving overall system efficiency, accuracy, and user adaptability. Application fields include smart buildings, medical settings, public transportation, factories, commercial facilities, smart homes, disaster response systems, and educational support systems. Furthermore, for AI model training, past data and analysis, evaluation, and provision history, user feedback, response history during abnormal events, and the like are used, and weight optimization is performed based on loss functions (e.g., maximization of accuracy, minimization of misjudgment, maximization of user satisfaction), enabling continuous improvement of accuracy and enhancement of environmental adaptability. Thus, the present invention not only automates human tasks, but fundamentally improves multi-stage information processing efficiency, accuracy, and user adaptability in computer technology itself.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, evaluation unit, and provision unit is implemented, for example, by at least one of a smart device 14 and a data processing apparatus 12. For example, the collection unit collects data using a temperature sensor, humidity sensor, voice sensor, and surveillance camera of the smart device 14. The analysis unit is implemented by a specific processing unit 290 of the data processing apparatus 12 and analyzes the collected data using generative AI to filter important information. The evaluation unit is implemented by the specific processing unit 290 of the data processing apparatus 12 and provides evaluation support based on the filtered information. The provision unit is implemented by a control unit 46A of the smart device 14 and provides the information obtained by the evaluation unit to a user in real time. The correspondence between each unit and the device or control unit is not limited to the examples described above and various modifications are possible.

### Second Embodiment

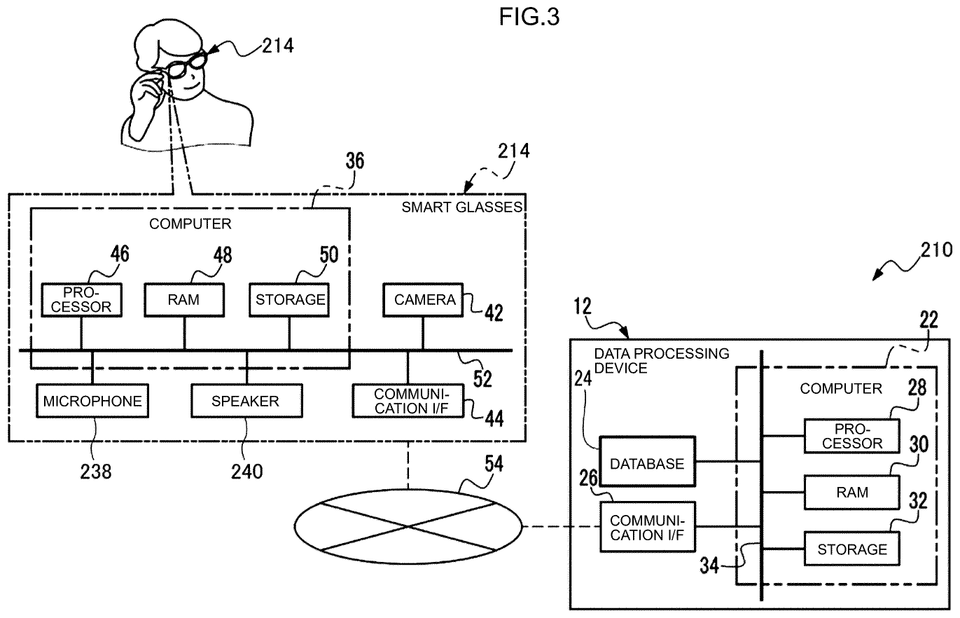

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

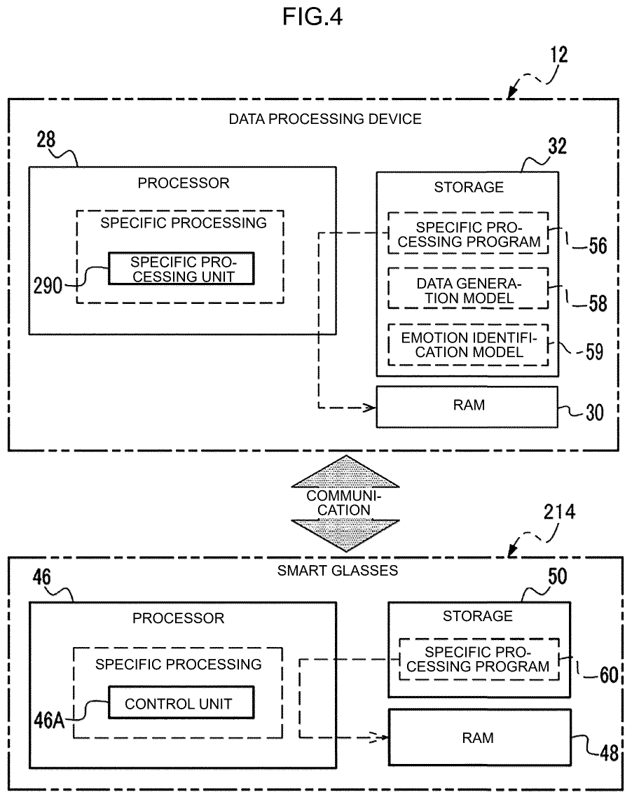

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, evaluation unit, and provision unit is implemented, for example, by at least one of smart glasses 214 and a data processing apparatus 12. For example, the collection unit collects data using a temperature sensor, humidity sensor, voice sensor, and surveillance camera of the smart glasses 214. The analysis unit is implemented by a specific processing unit 290 of the data processing apparatus 12 and analyzes the collected data using generative AI to filter important information. The evaluation unit is implemented by the specific processing unit 290 of the data processing apparatus 12 and provides evaluation support based on the filtered information. The provision unit is implemented by a control unit 46A of the smart glasses 214 and provides the information obtained by the evaluation unit to a user in real time. The correspondence between each unit and the device or control unit is not limited to the examples described above and various modifications are possible.

### Third Embodiment

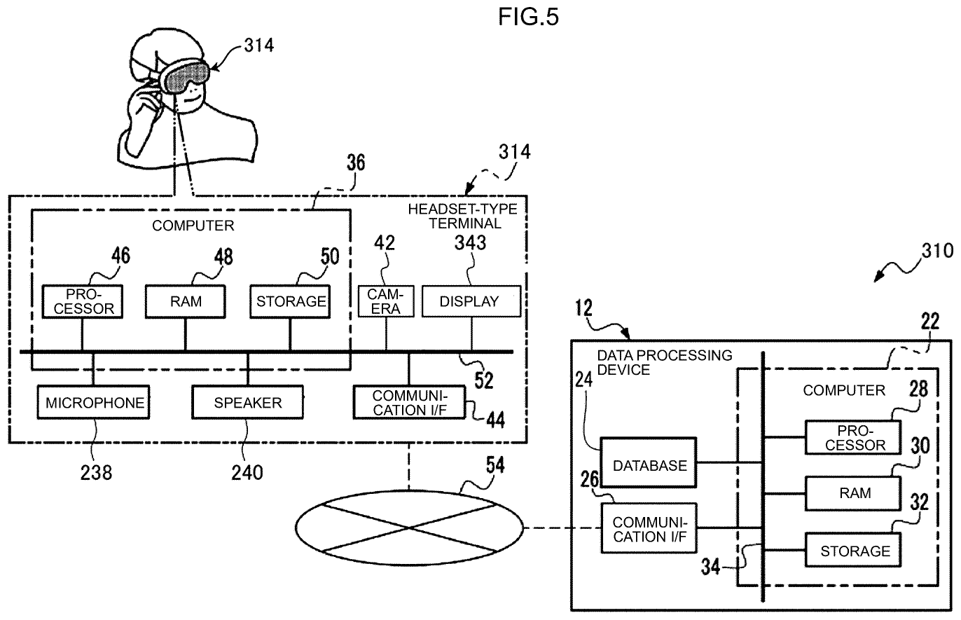

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

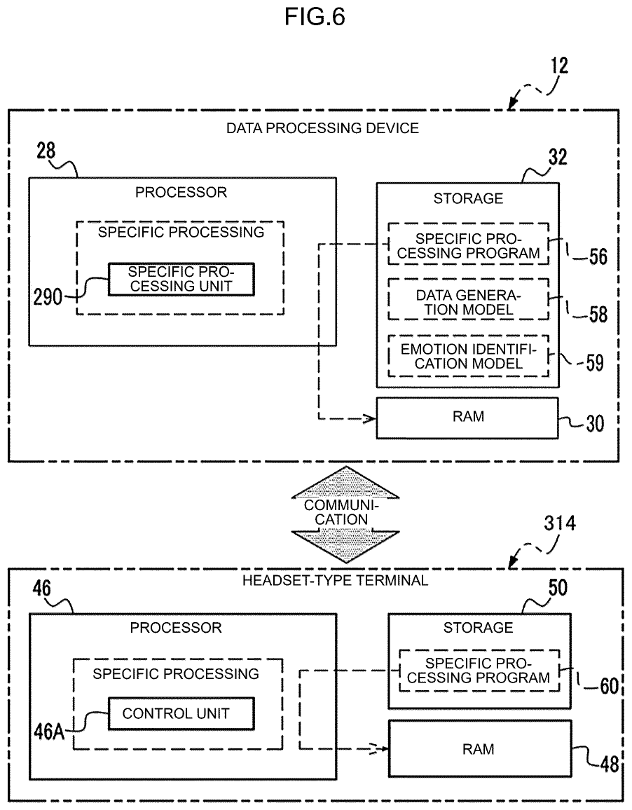

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, evaluation unit, and provision unit is implemented, for example, by at least one of a headset-type terminal 314 and a data processing apparatus 12. For example, the collection unit collects data using a temperature sensor, humidity sensor, voice sensor, and surveillance camera of the headset-type terminal 314. The analysis unit is implemented by a specific processing unit 290 of the data processing apparatus 12 and analyzes the collected data using generative AI to filter important information. The evaluation unit is implemented by the specific processing unit 290 of the data processing apparatus 12 and provides evaluation support based on the filtered information. The provision unit is implemented by a control unit 46A of the headset-type terminal 314 and provides the information obtained by the evaluation unit to a user in real time. The correspondence between each unit and the device or control unit is not limited to the examples described above and various modifications are possible.

### Fourth Embodiment

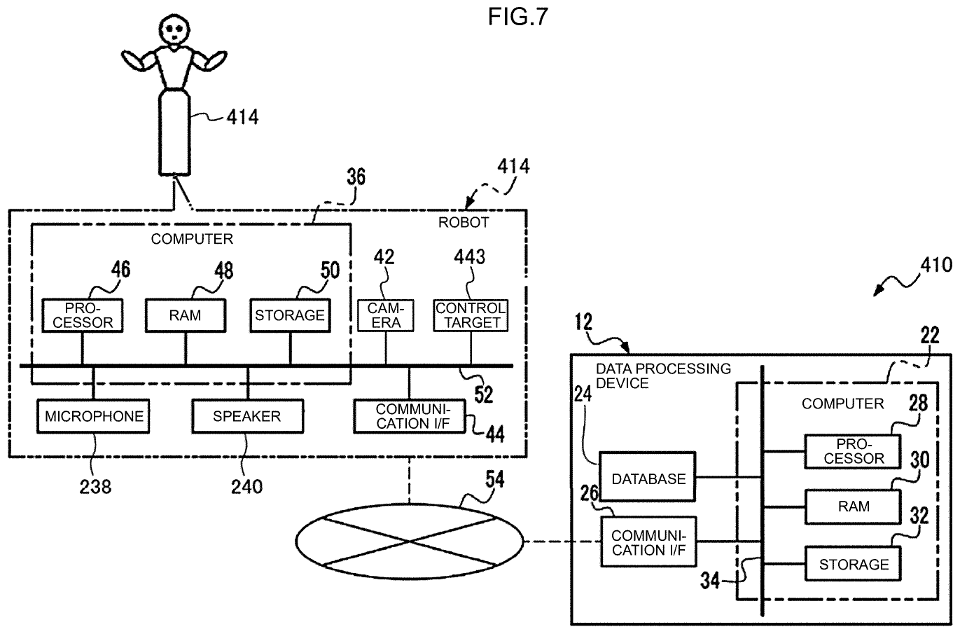

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

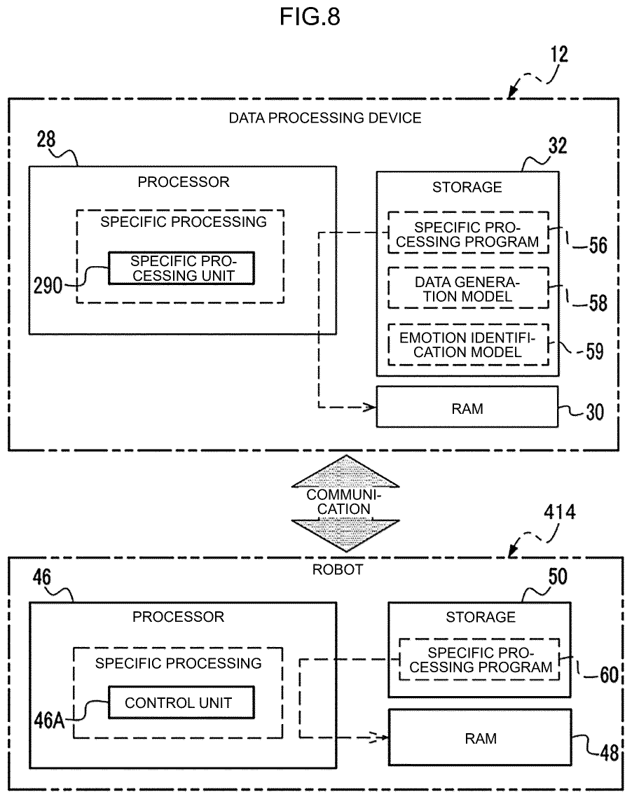

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, evaluation unit, and provision unit is implemented, for example, by at least one of a robot 414 and a data processing apparatus 12. For example, the collection unit collects data using a temperature sensor, humidity sensor, voice sensor, and surveillance camera of the robot 414. The analysis unit is implemented by a specific processing unit 290 of the data processing apparatus 12 and analyzes the collected data using generative AI to filter important information. The evaluation unit is implemented by the specific processing unit 290 of the data processing apparatus 12 and provides evaluation support based on the filtered information. The provision unit is implemented by a control unit 46A of the robot 414 and provides the information obtained by the evaluation unit to a user in real time. The correspondence between each unit and the device or control unit is not limited to the examples described above and various modifications are possible.

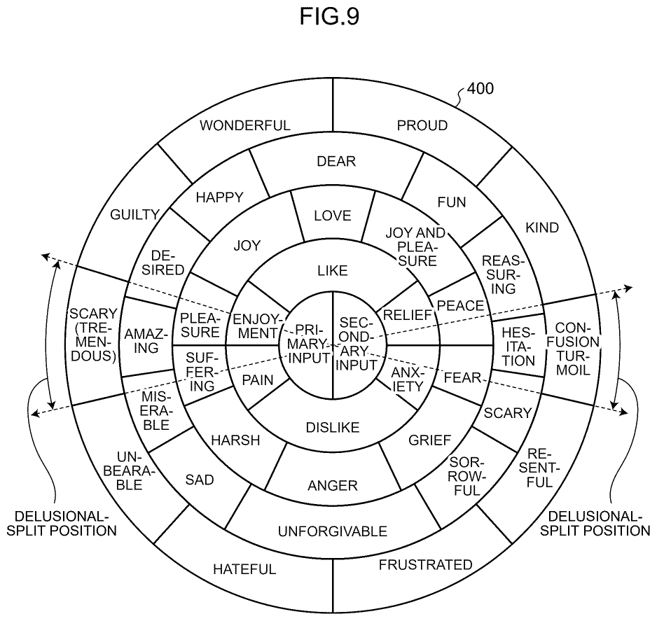

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

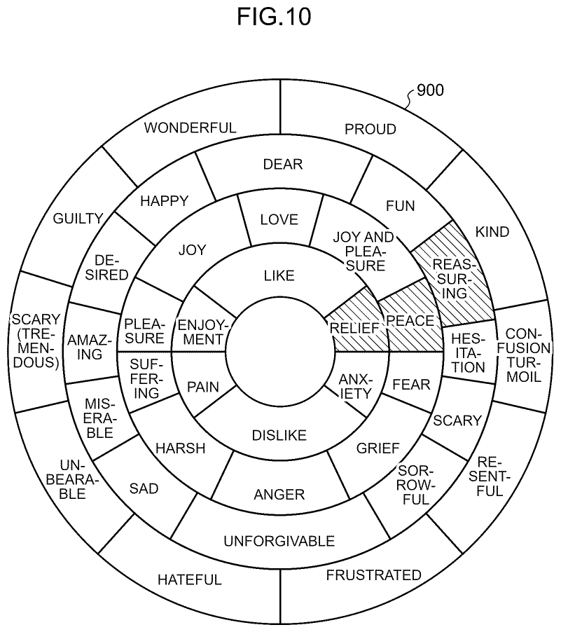

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect data; an analysis unit configured to analyze the data collected by the collection unit and filter important information; an evaluation unit configured to provide evaluation support based on the information filtered by the analysis unit; and a provision unit configured to provide the information obtained by the evaluation unit to a user in real time.
(Supplementary Note 2)The system according to Supplementary Note 1, wherein the collection unit collects data using a temperature sensor, a humidity sensor, a voice sensor, and a surveillance camera.
(Supplementary Note 3)The system according to Supplementary Note 1, wherein the analysis unit converts broadcast content inside a train into text based on the collected data.
(Supplementary Note 4)The system according to Supplementary Note 1, wherein the analysis unit analyzes emergency broadcasts within a facility based on the collected data and presents appropriate evacuation routes.
(Supplementary Note 5)The system according to Supplementary Note 1, wherein the provision unit sends notifications to a smartphone or tablet so that the user can immediately obtain necessary information.
(Supplementary Note 6)The system according to Supplementary Note 1, wherein the collection unit estimates a user's emotion and adjusts the timing of data collection based on the estimated emotion of the user.
(Supplementary Note 7)The system according to Supplementary Note 1, wherein the collection unit analyzes past data collection history and selects an appropriate collection method.
(Supplementary Note 8)The system according to Supplementary Note 1, wherein the collection unit performs filtering during data collection based on the user's current situation or field of interest.
(Supplementary Note 9)The system according to Supplementary Note 1, wherein the collection unit estimates a user's emotion and determines the priority of data to be collected based on the estimated emotion of the user.
(Supplementary Note 10)The system according to Supplementary Note 1, wherein the collection unit preferentially collects highly relevant data during data collection based on the user's geographic location information.
(Supplementary Note 11)The system according to Supplementary Note 1, wherein the collection unit analyzes the user's social media activity during data collection and collects relevant data.
(Supplementary Note 12)The system according to Supplementary Note 1, wherein the analysis unit estimates a user's emotion and adjusts the expression method of analysis based on the estimated emotion of the user.
(Supplementary Note 13)The system according to Supplementary Note 1, wherein the analysis unit adjusts the level of detail of analysis during analysis based on the importance of the data.
(Supplementary Note 14)The system according to Supplementary Note 1, wherein the analysis unit applies different analysis algorithms during analysis according to the category of the data.
(Supplementary Note 15)The system according to Supplementary Note 1, wherein the analysis unit estimates a user's emotion and adjusts the length of analysis based on the estimated emotion of the user.
(Supplementary Note 16)The system according to Supplementary Note 1, wherein the analysis unit determines the priority of analysis during analysis based on the timing of data collection.
(Supplementary Note 17)The system according to Supplementary Note 1, wherein the analysis unit adjusts the order of analysis during analysis based on the relevance of the data.
(Supplementary Note 18)The system according to Supplementary Note 1, wherein the evaluation unit estimates a user's emotion and adjusts the evaluation method based on the estimated emotion of the user.
(Supplementary Note 19)The system according to Supplementary Note 1, wherein the evaluation unit optimizes the evaluation algorithm during evaluation by referring to past evaluation data.
(Supplementary Note 20)The system according to Supplementary Note 1, wherein the evaluation unit performs evaluation during evaluation by considering attribute information of the data submitter.
(Supplementary Note 21)The system according to Supplementary Note 1, wherein the evaluation unit estimates a user's emotion and determines the priority of evaluation based on the estimated emotion of the user.
(Supplementary Note 22)The system according to Supplementary Note 1, wherein the evaluation unit performs evaluation during evaluation by considering the geographic distribution of the data.
(Supplementary Note 23)The system according to Supplementary Note 1, wherein the evaluation unit improves the accuracy of evaluation during evaluation by referring to related literature of the data.
(Supplementary Note 24)The system according to Supplementary Note 1, wherein the provision unit estimates a user's emotion and adjusts the method of information provision based on the estimated emotion of the user.
(Supplementary Note 25)The system according to Supplementary Note 1, wherein the provision unit selects an optimal provision method during information provision by referring to the user's past operation history.
(Supplementary Note 26)The system according to Supplementary Note 1, wherein the provision unit customizes the content of provision during information provision based on the user's current situation.
(Supplementary Note 27)The system according to Supplementary Note 1, wherein the provision unit estimates a user's emotion and determines the priority of information provision based on the estimated emotion of the user.
(Supplementary Note 28)The system according to Supplementary Note 1, wherein the provision unit selects an optimal provision method during information provision by considering the user's device information.
(Supplementary Note 29)The system according to Supplementary Note 1, wherein the provision unit analyzes the user's social media activity during information provision and adjusts the content of provision.

What is claimed is:

1. A system comprising:
a communication interface configured to communicate with a client terminal via a packet-switched network;
a memory storing a data generation model obtained by deep learning on a neural network, and an emotion identification model;
a database; and
circuitry configured to:
receive, from the client terminal via the communication interface, sensor data comprising at least one of voice data, image data, temperature data, or humidity data;
analyze the sensor data using the data generation model to extract important information by performing at least one of voice recognition, object detection, or anomaly detection;
estimate an emotion of a user by applying the emotion identification model to the sensor data;
generate, using the data generation model, evaluation data based on the extracted important information and the estimated emotion; and
transmit the evaluation data to the client terminal via the communication interface and the packet-switched network, the evaluation data causing the client terminal to present the evaluation data to the user.

2. The system according to claim 1, wherein the sensor data comprises voice data captured by a voice sensor, and wherein the circuitry is configured to convert broadcast content into text data by applying a voice recognition model to the voice data.

3. The system according to claim 1, wherein the sensor data comprises image data captured by a surveillance camera, and wherein the circuitry is configured to extract congestion status or hazardous area information by applying an object detection model to the image data.

4. The system according to claim 1, wherein the circuitry is further configured to analyze emergency broadcast content received in the sensor data and generate evacuation route data as the evaluation data by integrating facility map data and congestion status data.

5. The system according to claim 1, wherein the circuitry is further configured to adjust a timing of receiving the sensor data from the client terminal based on the estimated emotion, such that when the estimated emotion indicates stress, the circuitry reduces a frequency of receiving the sensor data, and when the estimated emotion indicates relaxation, the circuitry increases the frequency.

6. The system according to claim 1, wherein the circuitry is further configured to analyze a past data collection history stored in the database and select an optimal collection method based on the past data collection history using at least one of a decision tree, a random forest, or a reinforcement learning model.

7. The system according to claim 1, wherein the circuitry is further configured to perform filtering on the sensor data based on at least one of a current situation of the user or a field of interest of the user, the current situation comprising a location of the user.

8. The system according to claim 1, wherein the circuitry is further configured to determine a priority of the sensor data to be processed based on the estimated emotion, such that when the estimated emotion indicates stress, the circuitry preferentially processes sensor data having a high importance attribute.

9. The system according to claim 1, wherein the circuitry is further configured to receive geographic location information from the client terminal via the communication interface, and to preferentially process sensor data associated with a geographic region corresponding to the geographic location information.

10. The system according to claim 1, wherein the circuitry is further configured to receive social media activity data from the client terminal, analyze the social media activity data using a natural language processing model, and adjust a type of sensor data to be processed based on the analyzed social media activity data.

11. The system according to claim 1, wherein the circuitry is further configured to adjust an expression method of the evaluation data based on the estimated emotion, such that when the estimated emotion indicates nervousness, the circuitry generates the evaluation data in a simplified format, and when the estimated emotion indicates relaxation, the circuitry generates the evaluation data in a detailed format.

12. The system according to claim 1, wherein the circuitry is further configured to calculate an importance score for the sensor data and adjust a level of detail of the analysis based on the importance score, such that detailed analysis is performed for sensor data having a high importance score and simplified analysis is performed for sensor data having a low importance score.

13. The system according to claim 1, wherein the circuitry is further configured to apply different analysis algorithms according to a category of the sensor data, such that for voice data, the circuitry applies a voice recognition algorithm, for image data, the circuitry applies an image recognition algorithm, and for text data, the circuitry applies a natural language processing algorithm.

14. The system according to claim 1, wherein the circuitry is further configured to adjust a length of the evaluation data based on the estimated emotion, such that when the estimated emotion indicates urgency, the circuitry generates a concise evaluation result, and when the estimated emotion indicates relaxation, the circuitry generates a detailed evaluation result.

15. The system according to claim 1, wherein the circuitry is further configured to determine a priority of analysis based on a timestamp associated with the sensor data, such that sensor data having a more recent timestamp is analyzed with a higher priority.

16. The system according to claim 1, wherein the circuitry is further configured to optimize an evaluation algorithm by referring to past evaluation data stored in the database, the optimization comprising adjusting weight coefficients and threshold values based on the past evaluation data.

17. The system according to claim 1, wherein the circuitry is further configured to select a method of transmitting the evaluation data to the client terminal based on at least one of the estimated emotion or a past operation history of the user stored in the database, the method comprising at least one of a push notification, an email notification, or a voice notification.

18. A system comprising:
a communication interface configured to communicate, via a packet-switched network conforming to at least one of a 5G, Wi-Fi, or Bluetooth communication standard, with a client terminal comprising a microphone, a speaker, a camera having a CMOS image sensor, and a display;
a processor;
a random-access memory;
a memory storing a data generation model obtained by deep learning on a neural network, and an emotion identification model;
a database; and
circuitry configured to:
receive, from the client terminal via the communication interface, sensor data comprising at least one of voice data captured by the microphone, image data captured by the camera, temperature data, or humidity data;
analyze the sensor data using the data generation model to extract important information by performing at least one of voice recognition using a Transformer-based voice recognition model, object detection using a convolutional neural network, or anomaly detection;
estimate an emotion of the user by applying the emotion identification model to at least one of the voice data or the image data;
generate, using the data generation model, evaluation data based on the extracted important information and the estimated emotion, the evaluation data comprising at least one of text data, voice data, or evacuation route data; and
transmit the evaluation data to the client terminal via the communication interface, the evaluation data causing the client terminal to present the evaluation data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a communication interface, a memory storing a data generation model obtained by deep learning on a neural network and an emotion identification model, and a database, the method comprising:
receiving, from a client terminal via the communication interface and a packet-switched network, sensor data comprising at least one of voice data, image data, temperature data, or humidity data;
analyzing the sensor data using the data generation model to extract important information by performing at least one of voice recognition, object detection, or anomaly detection;
estimating an emotion of a user by applying the emotion identification model to the sensor data;
generating, using the data generation model, evaluation data based on the extracted important information and the estimated emotion; and
transmitting the evaluation data to the client terminal via the communication interface and the packet-switched network, the evaluation data causing the client terminal to present the evaluation data to the user.
